(19) United States
(12) Patent Application Publication
(10) Pub. No.: US 2023/0372889 A1
(43) Pub. Date: Nov. 23, 2023

(54) DISTRIBUTOR SUPPORT SYSTEM FOR CHEMICAL FEED DISTRIBUTORS IN FLUIDIZED BED SYSTEMS

(71) Applicant: Dow Global Technologies LLC, Midland, MI (US)

(72) Inventors: Matthew T. Pretz, Lake Jackson, TX (US); Donald F. Shaw, Forked River, NJ (US); Richard Walter, Long Valley, NJ (US); Albert Meza, Cypress, TX (US); Fermin Sandoval, Pearland, TX (US); Quan Yuan, Sugarland, TX (US); Liwei Li, Lake Jackson, TX (US); Pritish Kamat, Pearland, TX (US)

(73) Assignee: Dow Global Technologies LLC, Midland, MI (US)

(21) Appl. No.: 18/247,141

(22) PCT Filed: Sep. 28, 2021
(86) PCT No.: PCT/US2021/052329

§ 371 Date: Mar. 29, 2023

Related U.S. Application Data
(60) Provisional application No. 63/085,261, filed on Sep. 30, 2020.

(51) Int. Cl. B01J 8/18; B01J 4/00; F23C 10/22

(52) U.S. Cl. CPC B01J 8/1818; B01J 8/1872; B01J 4/004; F23C 10/22; B01J 2208/00938; B01J 2208/00911

(57) ABSTRACT

A fluidized bed processing system include a vessel having a vessel wall and a plurality of chemical feed distributors coupled to the vessel wall and extending into an internal volume of the vessel. Each of the chemical feed distributors includes a distributor body forming a chemical feed flow path and a plurality of chemical feed outlets. The fluidized bed processing system further includes at least one intermediate beam having at plurality of slots spaced apart along a beam length. That intermediate beam is coupled to the vessel wall at both ends, each chemical feed distributor passes through one slot of the intermediate beam, and the intermediate beam provides vertical support for each of the plurality of chemical feed distributors. The fluidized bed processing system can include lateral guides. The intermediate beams and lateral guides support the chemical feed distributors vertically and laterally.

### CROSS-REFERENCE TO RELATED APPLICATION

This application claims the benefit of priority to U.S. Provisional Application No. 63/085,261, filed on Sep. 30, 2020, and entitled “Distributor Support System for Chemical Feed Distributors in Fluidized Bed Systems,” the entire contents of which are incorporated by reference herein.

### BACKGROUND

### Field

The present specification generally relates chemical processing and, more specifically, to systems and processes for introducing chemical feed streams.

### Technical Background

Gaseous chemicals may be fed into reactors or other vessels through feed distributors. Feed distributors may be utilized to promote balanced distribution of a feed chemical stream into such reactors or vessels. Such distribution of feed chemicals may promote preferred reactions. For example, in a combustor, balanced distribution of a fuel gas stream into the vessel can promote mixing of fuel gas with air for more complete combustion. In reactor vessels, balanced distribution of a feed chemical stream may promote more consistent contact between various reactants in the chemical feed stream or between the feed chemical stream and a catalyst. Also, this balanced distribution of the chemical feed stream may also promote better temperature distribution as heat generated from combustion or exothermic reactions is evenly distributed within the vessel.

### SUMMARY

Pipe distributors are widely used as chemical feed distributors in fluidized bed processing systems, such as fluidized bed reactors, fluidized bed combustors, or other fluidized bed apparatus. These fluidized bed processing systems can operate at high temperatures in excess of 600° C. Mechanically, cantilever-type pipe distributors operating at high temperature (e.g., greater than or equal to 600° C.) can be constructed up to 7-8 feet long with one end of the pipe distributor fixed at the vessel wall. With both ends supported at the vessel wall, pipe distributors operating at high temperature can be built up to 15 feet long across the vessel from vessel wall to vessel wall. However, in a larger scale fluidized bed system, the vessel can have an internal diameter of from 15 feet to 70 feet. The larger vessel size requires longer chemical feed distributors to distribute chemical feed across the entire 15 feet to 70 feet of the internal diameter. In vessels having internal diameters greater than about 15 feet, support only at the pipe ends attached to the vessel wall are no longer sufficient to adequately support the weight of the pipe distributors or to withstand the vertical forces imparted by materials flowing up or down through the vessel.

The weight of the additional length of the longer pipe distributors increases the stress on the pipe distributors at the point where the pipe distributors are attached to and pass through the vessel wall. Further, the amount of stress sufficient to cause damage and failure of the pipe distributors increases with increasing temperatures. Thus, at high operating temperatures (e.g., greater than or equal to 600° C.), the threshold stress that results in damage or mechanical failure of the pipe distributors is greatly reduced, which only increases the risk of mechanical failure of the pipe distributors for vessels having an inner diameter greater than 15 feet.

Additionally, as the temperature of the fluidized bed processing systems increases, the materials (often metals) of the pipe distributors undergo thermal expansion. As the length of the pipe distributors increases, the effects of thermal expansion of the pipe distributors are more pronounced in the length direction. Any restrictions on thermal expansion of the pipe distributors can further increase the stress placed on the pipe distributors, leading to increasing the probability of damage or mechanical failure of the pipe distributors.

Lateral forces may also act on pipe distributors in a fluidized bed systems, lateral forces on the pipe distributors can be caused by several effects, such as but not limited to solids movement, vapor bubbles traveling through the fluidized bed, liquid droplet vaporization and associated rapid volume expansion, or other effects. These lateral forces can potentially lead to lateral movement of the pipe distributors, resulting in mechanical failure, particularly at the point where the pipe distributor is coupled to the vessel wall. Therefore, ongoing needs exist for chemical feed distribution system that include chemical feed distributors and a distributor support system for supporting the chemical feed distributors vertically and laterally within the vessel, which also allowing for thermal expansion of the chemical feed distributors and components of the distributor support system.

The chemical feed distribution systems of the present disclosure meet these needs by providing a plurality of chemical feed distributors and the distributor support system that includes one or more intermediate beams orthogonal to the chemical feed distributors and having a plurality of slots through which the chemical feed distributors are disposed. The intermediate beams may provide vertical support to the chemical feed distributors to supplement vertical support at the end of the chemical feed distributor coupled to the vessel wall. The distributor support system may additionally include one or more lateral guides that may interconnect two or more chemical feed distributors to provide lateral support to the chemical feed distributors. The vertical and lateral support provided by the intermediate beams and lateral guides may reduce or prevent vertical and/or lateral displacement of the chemical feed distributors during operation of the fluidized bed system while allowing for thermal expansion of the intermediate beams, lateral guides, chemical feed distributors, or combinations of these. Reducing vertical and/or lateral movement of the chemical feed distributors may reduce or prevent stress on the chemical feed distributor and improve the service life of the chemical feed distributors. The improved service life and reduced probability of mechanical failure may improve process safety, among other features.

According to one or more aspects, a fluidized bed processing system may include a vessel including a vessel wall and a plurality of chemical feed distributors coupled to the vessel wall and extending from the vessel wall into an internal volume of the vessel. Each of the chemical feed distributors may include a distributor body forming a chemical feed flow path and a plurality of chemical feed outlets distributed along a length of the distributor body. The fluidized bed processing system may further include at least one intermediate beam that may include a plurality of slots spaced apart along a beam length. The at least one intermediate beam may be coupled to the vessel wall at both ends. Each chemical feed distributor may pass through one slot of at least one intermediate beam. The at least one intermediate beam may provide vertical support for each of the plurality of chemical feed distributors.

Additional features and advantages will be set forth in the detailed description that follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 schematically depicts a cross-sectional view of a fluidized bed processing system, according to one or more embodiments shown and described herein;

FIG. 2 schematically depicts a top cross-sectional view of a fluidized bed processing system comprising a chemical feed distribution system, according to one or more embodiments shown and described herein;

FIG. 3 schematically depicts a perspective view of a portion of a chemical feed distribution system of the fluidized bed processing system of FIG. 2, according to one or more embodiments shown and described herein;

FIG. 4A schematically depicts a side perspective view of a chair supporting one end of an intermediate beam of the chemical feed distribution system of FIG. 3, according to one or more embodiments shown and described herein;

FIG. 4B schematically depicts a side view of the chair of FIG. 4A, according to one or more embodiments shown and described herein;

FIG. 4C schematically depicts a bottom perspective view of the chair of FIG. 4A, according to one or more embodiments shown and described herein;

FIG. 5 schematically depicts a side view of a portion of another embodiment of an intermediate beam of the chemical feed distribution system of FIG. 3, according to one or more embodiments shown and described herein;

FIG. 6 schematically depicts a side view of a portion of still another embodiment of an intermediate beam of the chemical feed distribution system of FIG. 3, according to one or more embodiments shown and described herein;

FIG. 7 schematically depicts a top perspective view of a lateral guide of the chemical feed distribution system of FIG. 2, according to one or more embodiments shown and described herein;

FIG. 8 schematically depicts a side view of the lateral guide of FIG. 7, according to one or more embodiments shown and described herein;

FIG. 9 schematically depicts a side view of another lateral guide, according to one or more embodiments shown and described herein;

FIG. 10A schematically depicts a top perspective view of the lateral guide of FIGS. 8 and 9 position proximate to terminal ends of the chemical feed distributors, according to one or more embodiments shown and described herein;

FIG. 10B schematically depicts a top cross-sectional view of the lateral guide of FIG. 10A positioned proximate to terminal ends of the chemical feed distributors, according to one or more embodiments shown and described herein;

FIG. 11 schematically depicts a perspective view of one or more end guides engaged with terminal ends of the chemical feed distributors, according to one or more embodiments shown and described herein;

FIG. 12 schematically depicts a side view of the end guide of FIG. 11, according to one or more embodiments shown and described herein;

FIG. 13 schematically depicts a top view of the end guide of FIG. 11, according to one or more embodiments shown and described herein;

FIG. 14 schematically depicts a top perspective view of a T-distributor of the fluidized bed processing system of FIG. 2, according to one or more embodiments shown and described herein;

FIG. 15 schematically depicts a side view of a support for the ends of the T-distributor of FIG. 14, according to one or more embodiments shown and described herein;

FIG. 16 schematically depicts a perspective view of a chemical feed distributor of the fluidized bed processing system of FIG. 2, according to one or more embodiments shown and described herein;

FIG. 17 schematically depicts a side cross-sectional view of the chemical feed distributor of FIG. 16, according to one or more embodiments shown and described herein;

FIG. 18 schematically depicts a front cross-sectional view of a chemical feed distributor, according to one or more embodiments shown and described herein;

FIG. 19 schematically depicts a side cross-sectional view of another chemical feed distributor, according to one or more embodiments shown and described herein;

FIG. 20 schematically depicts a side cross-sectional view of still another chemical feed distributor, according to one or more embodiments shown and described herein;

FIG. 21 schematically depicts a top cross-sectional view of still another chemical feed distributor, according to one or more embodiments shown and described herein; and

FIG. 22 schematically depicts a top cross-sectional view of yet another chemical feed distributor, according to one or more embodiments shown and described herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

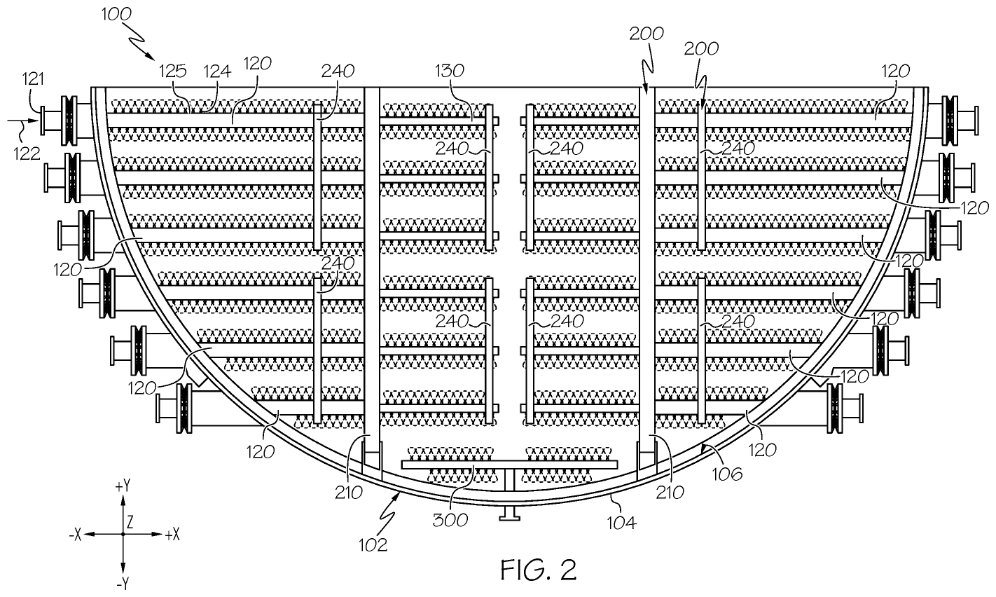

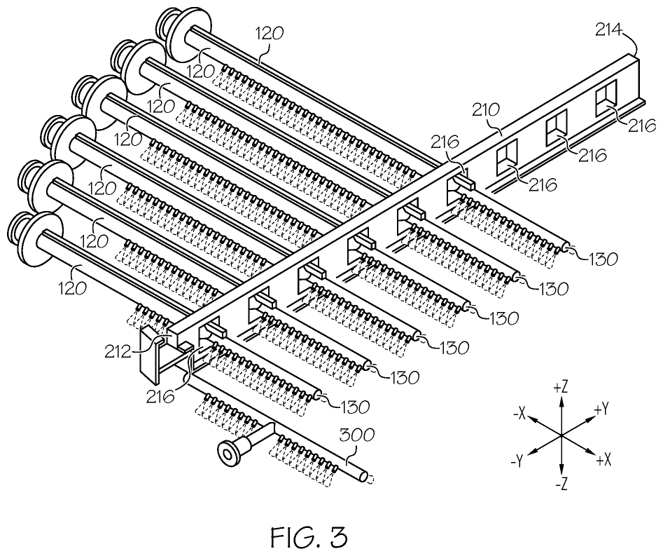

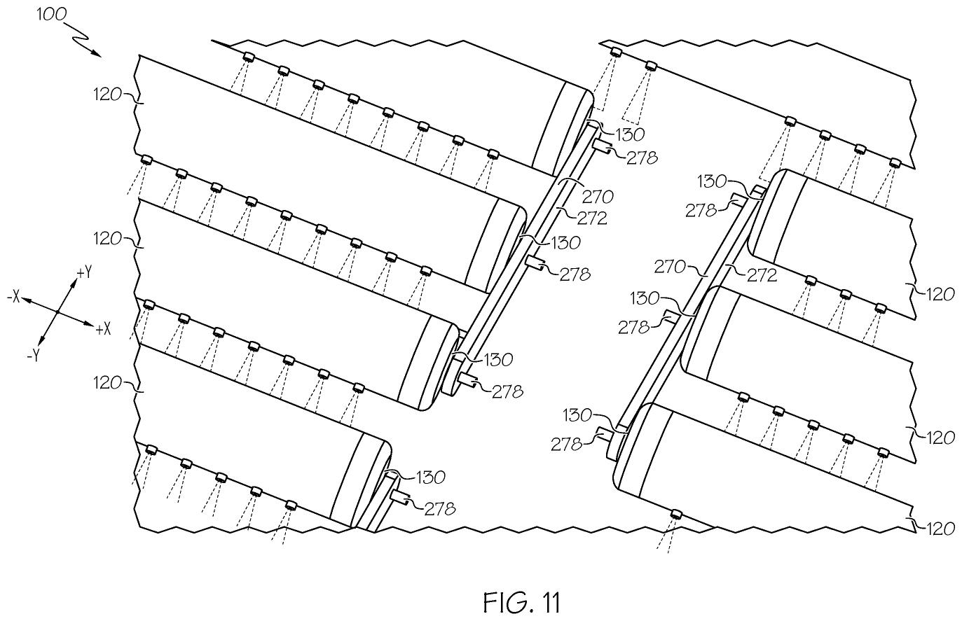

The present disclosure is directed to a fluidized bed processing system that includes a vessel, a plurality of chemical feed distributors disposed within the vessel, and a distributor support system that provides vertical and horizontal support to the plurality of chemical feed distributors. Referring to FIG. 2, one embodiment of the fluidized bed processing system 100 comprising the plurality of chemical feed distributors 120 and the distributor support system 200 is schematically depicted. The fluidized bed processing system 100 may include a vessel 102 comprising a vessel wall 104. The fluidized bed processing system 100 may further include a plurality of chemical feed distributors 120 coupled to the vessel wall 104 and extending from the vessel wall 104 into an internal volume of the vessel 102. Each of the chemical feed distributors 120 may include a distributor body 125 and a plurality of chemical feed outlets 124 distributed along a length of the chemical feed distributor 120. The fluidized bed processing system 100 may include the distributor support system 200, which may include at least one intermediate beam 210 having plurality of slots 216 (FIG. 3) spaced apart along a beam length of the intermediate beam 210. The at least one intermediate beam 210 may be coupled to the vessel wall 104 at both ends. Each chemical feed distributors 120 may pass through one slot 216 of at least one intermediate beam 210 so that the at least one intermediate beam 210 provides vertical support for each of the plurality of chemical feed distributors 120. The distributor support system 200 may further include a plurality of lateral guides 240, a plurality of end guides 270 (FIG. 11), or both, which may be operable to provide lateral support to the chemical feed distributors 120. The distributor support system 200 may provide vertical and lateral support to the chemical feed distributors 120, which may reduce stress on the chemical feed distributors 120 and improve the service life of the chemical feed distributors 120.

As used in this disclosure, the term “coupled” may refer to a first component being connected to a second component either directly or indirectly, such as through one or more third components that coupled the first component to the second component. The term “coupled” may include rigidly or fixedly coupled, in which the first component and the second component are connected so that the two components are not moveable relative to one another. The term “coupled” may also include non-rigid coupling, in which the first component and the second component are coupled in a manner that allows one of the components to move relative to the other component. “Slidably coupled” may refer to the first component directly or indirectly connected to the second component such that the first component may slide in at least one direction relative to the second component.

As used in this disclosure, the terms “upstream” and “downstream” may refer to the relative positioning of elements with respect to the direction of flow of the process streams. A first element of a system may be considered “upstream” of a second element if process streams flowing through the system encounter the first element before encountering the second element. Likewise, a second element may be considered “downstream” of the first element if the process streams flowing through the system encounter the first element before encountering the second element.

In the drawings, the +/−Z direction of the coordinate axis generally corresponds to the vertical direction which is parallel to the direction of the gravitational force vector. The +/−X direction of the coordinate axis is perpendicular to the +/−Z axis and generally parallel to the chemical feed distributors, and the +/−Y direction of the coordinate axis is perpendicular to the +/−Z axis and orthogonal to the chemical feed distributors.

As used in this disclosure, a “chemical feed” may refer to any process feed stream or fuel gas, such as, but not limited to, methane, natural gas, ethane, propane, hydrogen, or any gas that comprises energy value upon combustion. Additionally, as used in this disclosure, a “vessel” may refer to a hollow container for holding a liquid, gas, or solid, such as, a reactor or combustor (which is a type of reactor) in which one or more chemical reactions may occur between one or more reactants optionally in the presence of one or more catalysts.

As used in this disclosure, the term “combustor” may refer to a reactor for conducting a combustion reaction.

Additionally, as used in the present disclosure “coking” may refer to the formation of carbonaceous deposits, or coke. “Plugging” may refer to an accumulation of coke such that a passage or port may be partially restricted or completely blocked.

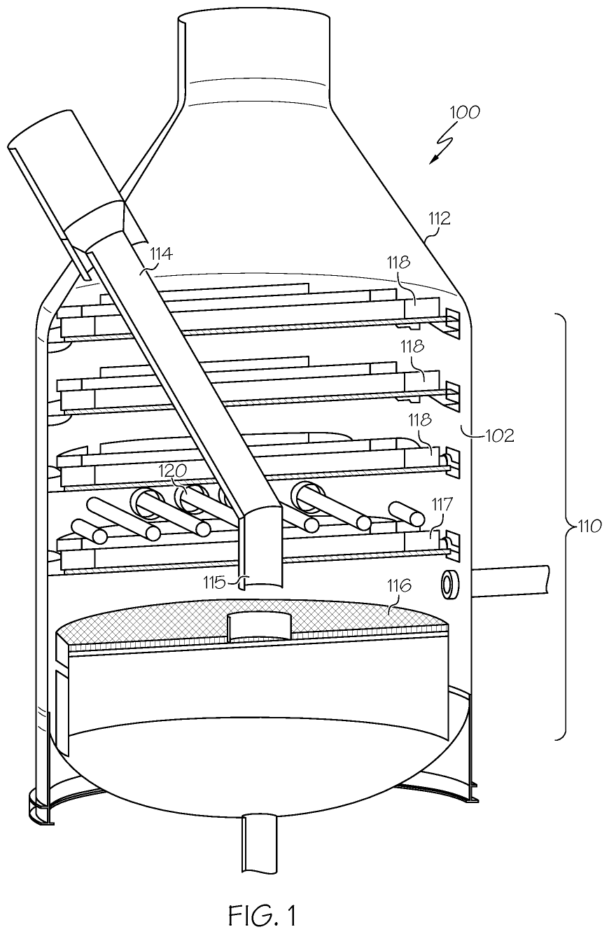

Referring to FIG. 1, a schematic cutaway view of a fluidized bed processing system 100 according to embodiments of the present disclosure is depicted. The fluidized bed processing system 100 may include a vessel 102 that may have a lower portion 110 generally in the shape of a cylinder and an upper portion comprising a frustum 112. The angle between the frustum 112 and an internal horizontal imaginary line drawn at the intersection of the frustum 112 and the lower portion 110 may range from 10 to 80 degrees. All individual values and subranges from 10 to 80 degrees are included and disclosed herein; for example the angle between the tubular and frustum 112 components can range from a lower limit of 10, 40, or 60 degrees to an upper limit of 30, 50, 70, or 80 degrees. In embodiments, the angle can change along the height of the frustum 112, either continuously or discontinuously. In embodiments, the vessel 102 may be, or may not be, lined with a refractory material.

The fluidized bed processing system 100 may be a reactor, a combustor, a catalyst conditioner, or a catalyst stripper. In embodiments, the fluidized bed processing system 100 may be a reactor, combustor, catalyst conditioner, or catalyst stripper in a catalytic dehydrogenation process. In embodiments, the fluidized bed processing system 100 may be a fluidized fuel gas combustor for heating catalysts or at least partially regenerating catalysts in a catalytic dehydrogenation process. However, as detailed herein, fluidized bed processing system 100 may be used in various capacities in chemical processing systems.

As shown in FIG. 1, catalyst may enter the vessel 102 through downcomer 114, such as when the fluidized bed processing system 100 is a fluidized catalyst combustor and the catalyst is a spent or deactivated catalyst. Alternatively or additionally, in embodiments, the catalyst may enter the vessel 102 from a side inlet (not shown) or from a bottom feed (not shown), passing upward through the air distributor 116. The catalyst may impinge upon and may be distributed by a splash guard. The vessel 102 may further include the air distributors 116, which may be located at or slightly below the height of the splash guard. Above the air distributors 116 and the outlet 115 of downcomer 114 may be a grid 117. Above the grid 117 may be the plurality of chemical feed distributors 120. One or more additional grids 118 may be positioned within the vessel 102 above the chemical feed distributors 120. In embodiments, the chemical feed distributors 120 may enter the vessel 102 and traverse substantially across the vessel 102 as described in U.S. Pat. No. 9,889,418, which is incorporated by reference herein.

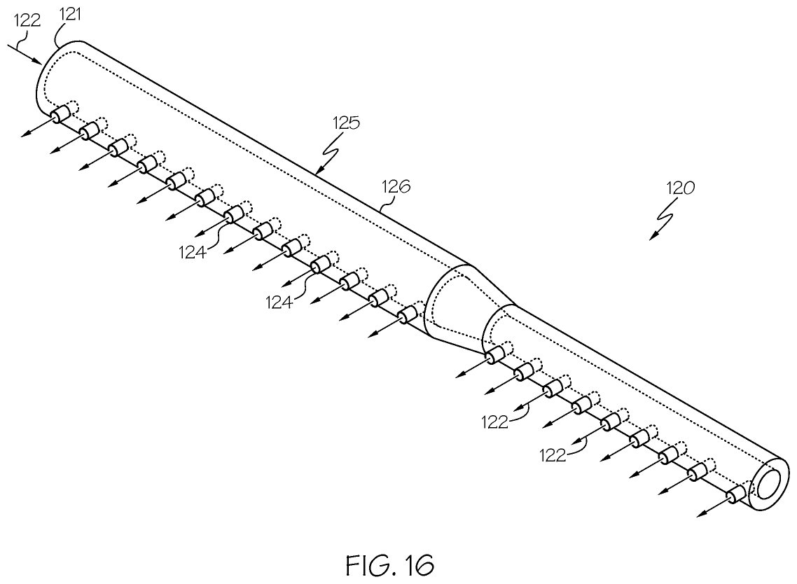

Referring now to FIG. 2, each of the chemical feed distributors 120 may comprise a chemical feed inlet 121 that may pass a chemical feed stream 122 into the chemical feed distributor 120. Accordingly, the chemical feed stream 120 may pass through the chemical feed inlet 121 into the chemical feed distributor 120. As described herein, the chemical feed inlet 121 may refer to a place of entry into the vessel 102 that allows the chemical feed distributor 120 and the chemical feed stream 122 within the chemical feed distributor 120 to pass into the vessel 102. Referring to FIGS. 16-18, each chemical feed distributor 120 may comprise a distributor body 125, which may comprise one or more walls 126. The distributor body 125 may also include a plurality of chemical feed outlets 124. The plurality of chemical feed outlets 124 may be openings in the one or more walls 126 of the distributor body 125 and may provide a passage for the chemical feed stream 122 from the chemical feed distributor 120 into the vessel 102.

In embodiments, the plurality of chemical feed outlets 124 may be arranged in a singular row along the chemical feed distributor 120. In other embodiments, the plurality of chemical feed outlets 124 may be arrange in alternating positions along the chemical feed distributor 120, such as two rows. It is contemplated that the chemical feed outlets 124 may be arrange in any configuration along the chemical feed distributor 120. Referring to FIG. 18, each of the plurality of chemical feed outlets 124 may comprise an orifice 137 at the start of each chemical feed outlet 124 to create pressure drop and create even distribution of the chemical feed. The chemical feed distributors 120 may also include a diffuser 138 coupled to the distributor wall 126 at each of the chemical feed outlets 124. The diffusers 138 may slow the superficial gas velocity passing out of the orifices 137 to reduce or prevent catalyst attrition, damage to internal structures of the vessel 102, or damage to the chemical feed distributors 120. The diffusers may permit the gas velocity to be in a range from 50 feet per second (ft/sec) to 300 ft/sec.

The one or more walls 126 may define an elongated chemical feed stream flow path 127. The plurality of chemical feed outlets 124 may be spaced along at least a portion of the length of the elongated chemical feed stream flow path 127. Individual ones of the plurality of chemical feed outlets 124 may be operable to pass portions of the chemical feed stream 122 out of the chemical feed distributor 120 and into a vessel 102. The total flow rate of the chemical feed stream 122 entering the chemical feed distributor 120 may be equal to the flow rate of the portions of the chemical feed stream 122 passing through individual ones of the plurality of chemical feed outlets 124 and into the vessel 102.

Referring again to FIG. 2, the vessel 102 may have an internal diameter greater than or equal to 15 feet (4.6 meters, where 1 foot is equal to 0.3048 meters), such as from 15 feet (4.6 meters) to 70 feet (21.3 meters). As previously discussed, when the internal diameter of the vessel 102 exceeds about 15 feet, longer chemical feed distributors 120 are needed to distribute chemical feed across the entire 15 feet to 70 feet of the internal diameter. Cantilever-type chemical feed distributors 120 can be built up to 7-8 feet (2.1-2.4 meters) long with one end of the chemical feed distributor 120 fixed at the vessel wall 104. With both ends supported at the vessel wall 104, chemical feed distributors 120 can be built up to 15 feet long (4.57 meters) across the vessel 102. However, when the chemical feed distributors 120 exceed these limits (7-8 feet with one end coupled to the vessel wall or 15 feet with both ends coupled to the vessel wall), the weight of the additional length of the longer chemical feed distributors 120 can increase the stress on the chemical feed distributors 120 at the point where the chemical feed distributors 120 are attached to and pass through the vessel wall 104. Further, the amount of stress sufficient to cause damage and failure of the chemical distributors 120 increases with increasing temperatures. Thus, at high operating temperatures (e.g., greater than or equal to 600° C.), the threshold stress that results in damage or mechanical failure of the chemical feed distributors 120 is greatly reduced, which only increases the risk of mechanical failure of the chemical feed distributors 120 for vessels 102 having inner diameters greater than 15 feet (4.57 meters).

Additionally, as the temperature of the fluidized bed processing system 100 increases, the materials (often metals) of the chemical feed distributors 120 undergo thermal expansion. As the length of the chemical feed distributors 120 increases, the effects of thermal expansion of the chemical feed distributors 120 are more pronounced in the length direction. Any restrictions on thermal expansion of the chemical feed distributors 120 can further increase the stress placed on the chemical feed distributors 120, leading to increasing the probability of damage or mechanical failure of the chemical feed distributors 120.

Additionally, in fluidized bed processing systems, lateral forces on the chemical feed distributors 120 can be caused by several effects, such as but not limited to solids movement, vapor bubbles travelling through the fluidized bed, liquid droplet vaporization and associated rapid volume expansion, or other effects. These lateral forces can potentially lead to lateral movement of the chemical feed distributors 120, resulting in stress on the chemical feed distributors 120, particularly at the point where the pipe distributor is coupled to the vessel wall 104. The stresses on the chemical feed distributors 120 caused by vertical and/or lateral displacement during operation can result in mechanical failure of the chemical feed distributors 120.

Therefore, ongoing needs exist for fluidized bed processing systems 100 that provide support for the chemical feed distributors 120 to reduce stresses on the chemical feed distributors 120 and enable the use of larger vessels 102 with greater internal diameters. Referring now to FIG. 2, the fluidized bed processing systems 100 of the present disclosure include the vessel 102 and a chemical feed distribution system 110. The chemical feed distribution system 110 may include the plurality of chemical feed distributors 120 and a distributor support system 200. As previous discussed, each of the plurality of chemical feed distributors 120 may be coupled to the vessel wall 102 and may extend from the vessel wall 104 into the internal volume of the vessel 102. Each of the chemical feed distributors 120 includes a chemical feed inlet 121, a distributor body 125 forming a flow path and a plurality of chemical feed outlets 124 distributed along a length of the distributor body 125.

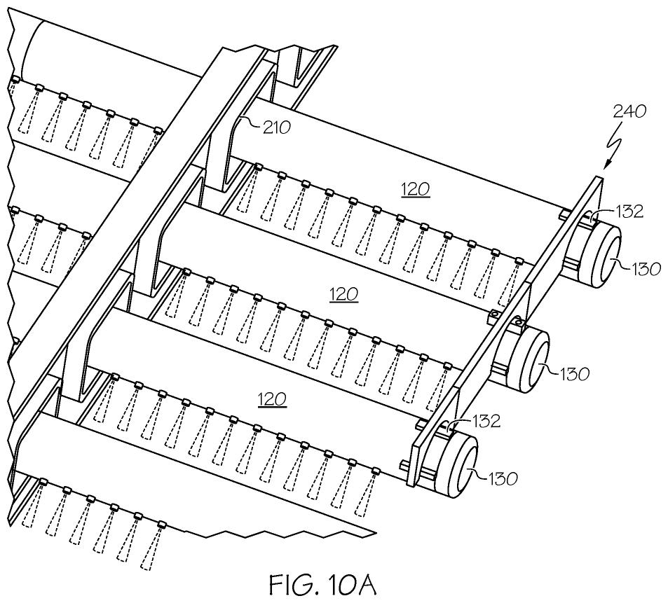

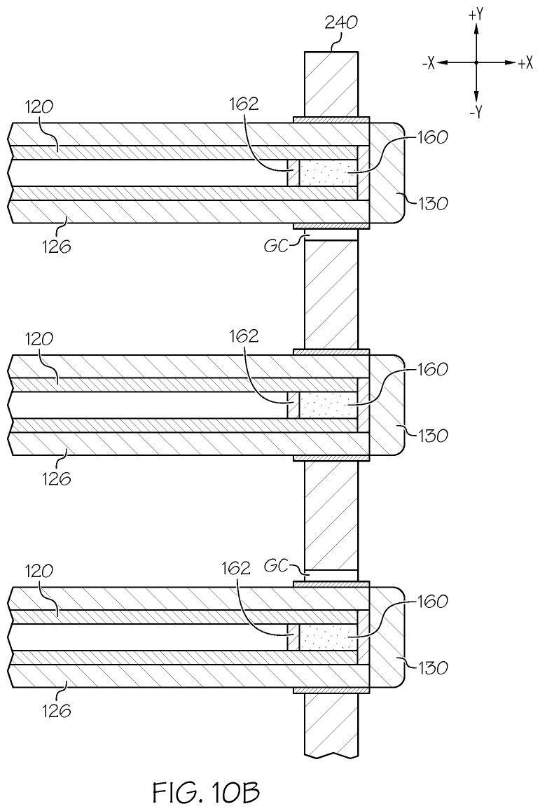

The distributor support system 200 may include one or a plurality of intermediate beams 210 operable to vertically support the chemical feed distributors 120. The distributor support system 200 may also include one or a plurality of lateral guides 240 operable to restrict lateral movement of the chemical feed distributors 120. Referring to FIG. 10, in embodiments, the distributor support system 200, optionally, may include one or a plurality of end guides 270 coupled to terminal ends 130 of the chemical feed distributors 120. The terminal end 130 of a chemical feed distributor 120 refers to the end that is not coupled to the vessel wall 104.

Referring now to FIGS. 2 and 3, as previously discussed, the distributor support system 200 may include one or a plurality of the intermediate beams 210, which may be oriented generally orthogonal to the plurality of chemical feed distributors 120. Each of the intermediate beams 210 may be coupled to the vessel wall 104 at both ends 212, 214 of the intermediate beam 210. Each intermediate beam 210 may include a plurality of slots 216 extending through the intermediate beam 210 and spaced apart along a length of the intermediate beam 210. Each slot 216 may receive one of the chemical feed distributors 120 so that the chemical feed distributor 120 passes through the slot 216. One or more of the chemical feed distributors 120 may each pass through one of the slots 216 in at least one of the intermediate beams 210. The intermediate beams 210 may provide vertical support (i.e., support in the +/−Z direction of the coordinate axis in FIG. 3) for each of the plurality of chemical feed distributors 120 disposed through the slots 216.

At least one end of each intermediate beam 210 may be slidable laterally (i.e., in the X-Y plane, such as in the +/−Y direction of the coordinate axis in FIGS. 2 and 3) relative to the vessel wall 104. Referring to FIG. 3, a first end 212, a second end 214, or both of each intermediate beams 210 may be slidably coupled to the vessel wall 104. Slidably coupling at least one of the first end 212, the second end 214, or both to the vessel wall 104 may allow for thermal expansion of the intermediate beams 210 during operation of the fluidized bed processing system 100. In embodiments, either the first side 212 or the second side 214 may be rigidly coupled to the vessel wall 104, such as to an inner surface 106 of the vessel wall 104. As used herein, the term “slidably coupled” refers to a first structure being non-rigidly coupled to a second structure so that the first structure is able to slide in at least one direction relative to the second structure.

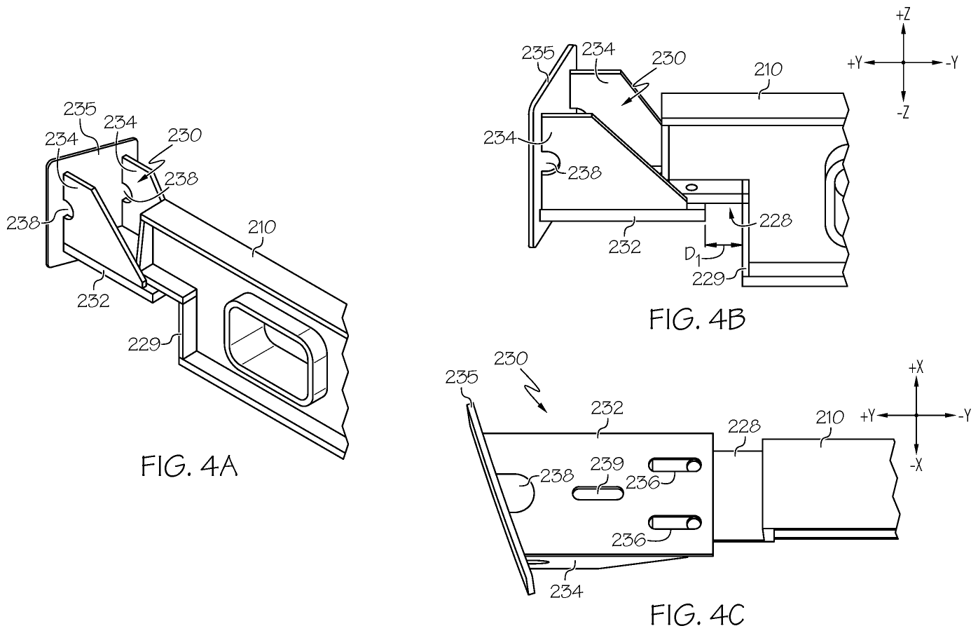

Referring to FIGS. 4A, 4B, and 4C, in embodiments, one or both ends of each of the intermediate beams 210 may be coupled to the vessel wall 104 by a chair 230 that may support the intermediate beams 210 while allowing the intermediate beams 210 to slide laterally (e.g., in the +/−Y direction of the coordinate axis in FIG. 4) relative to the chair 230 to accommodate thermal expansion of the intermediate beams 210 when heated to operating temperatures in excess of 600° C. Referring to FIG. 4A, each chair 230 may include a base 232, two sidewalls 234 extending vertically (i.e., in the + or − Z direction of the coordinate axis of FIG. 4B) from the base 232, and a mounting plate 235 for attaching the chair 230 to the vessel wall 104. In embodiments, the sidewalls 234 may extend vertically upward (i.e., in the +Z direction of the coordinate axis in FIG. 4) from the base plate 232 so that the intermediate beam 210 is disposed above the chair 230. Alternatively, in other embodiments, the sidewalls 234 may extend vertically downward (i.e., −Z direction) from the baseplate 232.

At least a portion of the end of the intermediate beam 210 may be received in the chair 230 in a cradle defined by the base 232 and two sidewalls 234. Referring to FIG. 4B, a portion of a bottom surface 228 of the intermediate beam 210 may contact the base 232 of the chair 230. The contact of the bottom surface 228 of the intermediate beam 210 with the base 232 may vertically support the intermediate beam 210 at the vessel wall. In embodiments, the end (first end 212, second end 214, or both) of the intermediate beam 210 may include a notch 229 defined by a vertical surface and the portion of the bottom surface 228 contacting the base 232 of the chair 230. The notch 229 may provide a gap D₁ that may allow for thermal expansion of the intermediate beam 210 when heated to the operating temperatures in excess of 600° C. without the vertical surface of the notch 229 contacting the base 232. In embodiments, the notch 229 may have dimensions such that when the end of the intermediate beam 210 is engaged with the chair 230, the gap D₁ between the vertical surface of the notch 229 and the base plate 232 of the chair 230 is greater than a length of each of the mounting slots 236. The sidewalls 234 of the chair 230 may restrict lateral movement of the intermediate beam 210 (e.g., movement in the +/−X direction of the coordinate axis of FIGS. 4B and 4C).

Referring to FIG. 4C, in embodiments, the base 232 of the chair 230 may include one or a plurality of mounting slots 236. The mounting slots 236 in the base 232 may allow the end of the intermediate beam 210 to be slidably coupled to the base 232 so that movement of the intermediate beam 210 in the vertical direction (e.g., the +/−Z direction in FIGS. 4B and 4C) is restricted, while the end of the intermediate beam 210 can slide in the +/−Y direction relative to the chair 230 to allow for thermal expansion of the intermediate beam 210 during heating of the system to the operating temperatures. In embodiments, the intermediate beam 210 may include one or pins that extend downward (e.g., −Z direction) through the mounting slots 236 in the chairs 230 to facilitate attachment of the intermediate beam 210 to the chair 230. Although shown and described herein as being disposed in the base 232 of the chairs 230, it is understood that the mounting slots 236 could also be positioned in the two sidewalls 234 of the chairs 230 in other embodiments.

When the intermediate beam 210 is slidably coupled to the vessel wall 104 at both the first end 212 and the second end 214 of the intermediate beam 210, each of the first end 212 and the second end 214 may be disposed and supported by one of the chairs 230. When both the first end 212 and the second end 214 are supported by chairs 230, each of the mounting slots 236 in each of the chairs 230 may have a length that is less than the incremental expansion length of the intermediate beam 210 and greater than 0.5 times the incremental expansion length of the intermediate beam 210. The length of the mounting slots 236 may be the dimension of the mounting slots 230 measured in the +/−Y direction of the coordinate axis of FIG. 4C. The incremental expansion length of the intermediate beam 210 represents the total amount of incremental thermal growth of the intermediate beam 210 in the +/−Y direction when heating the intermediate beam 210 from ambient temperature to the operating temperature of the fluidized bed processing system 100. The incremental expansion length can be the difference between the length L (FIG. 6) of the intermediate beam 210 at the operating temperatures of the fluidized bed processing system 100 (e.g., >600° C.) and the length L of the intermediate beam 210 at ambient temperature, such as at 25° C. In embodiments, the length of each of the mounting slots 236 may be from 0.5 to 0.8, from 0.51 to 0.7, or from 0.55 to 0.6 times the incremental expansion length of the intermediate beam 210. Limiting the length of the mounting slots 236 may cause the thermal expansion growth of the intermediate beam 210 to occur in both directions (i.e., in both the + and − Y direction of the coordinate axis in FIG. 4C). In other words, when the intermediate beam 210 thermally expands in a single direction, for whatever reason, the intermediate beam 210 will expand until the pins at one end contact the end of the mounting slots 236 in the chair 230 at that end. This contact will cause the thermal expansion of the intermediate beam 210 to proceed in the other direction as allowed by the remaining space in the mounting slots 236 of the other chair 230 at the other end of the beam. This allows the lengths of the mounting slots 236 and the overall size of the chairs 230 to be reduced.

When the intermediate beam 210 is fixedly coupled to the vessel wall 104 at one end and slideably coupled to the vessel wall 104 at the opposite end, only one of the first end 212 or second end 214 of the intermediate beam 210 is received and supported by one of the chairs 230. In these embodiments, the lengths of the mounting slots 236 in the single chair 230 may be greater than or equal to the incremental expansion length of the intermediate beam 210 to prevent restriction of the thermal expansion of the intermediate beam 210.

Referring again to FIG. 4C, in embodiments, the base 232 of the chairs 230 may include one or more openings 239 through the base 232. The openings 239 may allow for flow of catalyst and gases through the chairs 230 to reduce or prevent dead spots in the vessel 102. Referring to FIGS. 4A, 4B, and 4C, the base 232 and sidewalls 234 of the chairs 230 may additional include one or more cutouts 238 where the base 232 or sidewall 234 are welded to the mounting plate 235 or to the wall 104 of the vessel 102. The cutouts 238 at the edges of the base 232 and sidewalls 234 may reduce the welded seams between the base 232 and sidewalls 234, which may in turn reduce the amount of heat transferred from the chairs 230 and intermediate beams 210 engaged with the chairs 230 to the vessel wall 104. This may reduce the amount of heat loss from the internal volume of the vessel 102 through the vessel wall 104 to improve the thermal efficiency of the fluidized bed processing system 100.

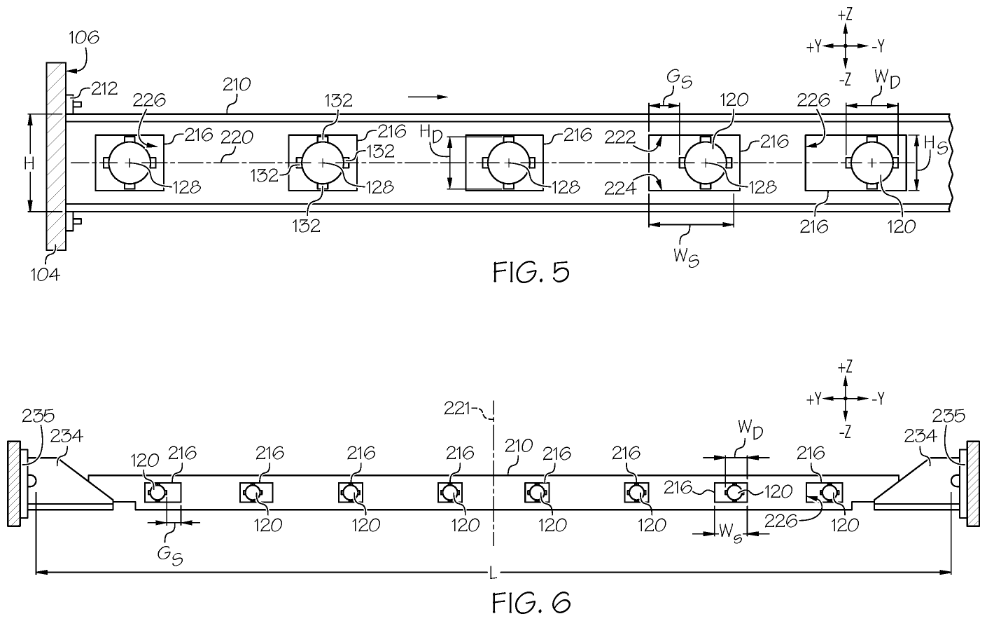

Referring now to FIG. 5, the slots 216 of each intermediate beam 210 may be spaced apart along the length of the intermediate beam 210 so that each of the slots 216 can receive one of the plurality of chemical feed distributors 120. Each of the slots 216 may be positioned vertically (i.e., in the +/−Z direction of the coordinate axis in FIG. 5) in between the top and bottom of the intermediate beam 210. In embodiments, the slots 216 may be positioned so that the slot centerline 220 of the slots 216 generally align with a centerline of the intermediate beam 210. In other embodiments, the slots 216 may be positioned so that the slot centerline 220 of the slots 216 is offset from the centerline of the intermediate beam 210 in the + or − Z direction of the coordinate axis in FIG. 5. The slot centerline 220 refers to a horizontal centerline parallel to the +/−Y axis of FIG. 5 and positioned at the vertical center of the slot 216 (e.g., center of the slot 216 in the +/−Z direction of the coordinate axis in FIG. 5).

Each of the chemical feed distributors 120 may be positioned through one of the slots 216 so that the distributor centerline 128 is generally vertically aligned with the slot centerline 220 of the slot 216 through which the chemical feed distributor 120 passes. This may enable thermal expansion of the intermediate beams 210 in the +Z and −Z direction without influencing the vertical positioning of the chemical feed distributors 120 within the vessel 102, which can cause stress at the point where each chemical feed distributor 120 is coupled to the vessel wall 104. The distributor centerline 128 refers to a horizontal centerline parallel to the +/−X axis of FIG. 5 and positioned at the vertical center of the chemical feed distributor 120 (e.g., center of the chemical feed distributor 120 in the +/−Z direction of the coordinate axis in FIG. 5). In embodiments, the chemical feed distributors may be vertically positioned relative to the slots 216 so that the distributor centerlines 128 of each of the plurality of chemical feed distributors 120 may deviate from the slot centerlines 220 of the slots 216 by less than 10% of the distributor height H_{D} of the chemical feed distributors 210. The distributor height H_{D} of the chemical feed distributors 210 may be the total height of the chemical feed distributors 210 in the vertical direction including the distributor walls 126 and any reinforcing bars 132 coupled to an outer surface of the distributor walls 126. In embodiments, the distributor centerline 128 of each of the plurality of chemical feed distributors 120 may be aligned at the same elevation (i.e., same +/−Z position of the coordinate axis in FIG. 5) as the slot centerline 220 of the slots 216.

The slot height H_{S} of each of the plurality of slots 216 may be sufficient to allow the chemical feed distributors 120 to pass through the slots 216 but close enough to the distributor height H_{D} to vertically support the chemical feed distributors 120 and restrict vertical movement (i.e., movement in the +/−Z direction of the coordinate axis of FIG. 5) of the chemical feed distributors 120 disposed therethrough. In embodiments, the slot height H_{S} of each of the slots 216 may be greater than 1 times the distributor height H_{D} and less than or equal to 1.2 time the distributor height H_{D}. The difference between the distributor height H_{D} of each of the plurality of chemical feed distributors 120 and the slot height H_{S} of the slots 216 in the at least one intermediate beam 210 may be sufficient to allow for some thermal expansion of the chemical feed distributors 120 disposed through the slots 216. In embodiments, a difference between the distributor height H_{D} of each of the plurality of chemical feed distributors 120 and the slot height H_{S} of the slots 216 may be less than or equal to 0.25 inches (1.27 centimeters (cm)), less than or equal to 0.20 inches (0.51 cm), less than or equal to 0.125 inches (0.32 cm), or even less than or equal to 0.06125 inches (0.16 cm). In embodiments, an outer surface of each chemical feed distributor 120 may contact the upper surface 222, the lower surface 224, or both of the slot 216 in the intermediate beams 210 through which the chemical feed distributor 120 is disposed.

Referring again to FIG. 5, the slots 216 in the intermediate beams 210 have slot widths W_{S} that are greater than the distributor width W_{D} of each of the chemical feed distributors 120 to allow for thermal expansion of the intermediate beams 210 without changing the horizontal position (i.e., position in the X-Y plane of the coordinate axis in the Figures) of the plurality of chemical feed distributors 120, which can cause stress leading to mechanical failure at the point where the chemical feed distributors 120 are coupled to the vessel wall 104. A clearance between each of the plurality of chemical feed distributors 120 and one or both side surfaces 226 of the slot 216 of the intermediate beam 210 may be sufficient to allow for thermal growth of the intermediate beam 210 without the contact between the intermediate beam 210 and chemical feed distributors 120 changing the lateral position of any of the plurality of chemical feed distributors 120. In embodiments, a difference between the distributor width W_{D} of the chemical feed distributors 120 and the slot width W_{S} of each of the slots 216 may be greater than or equal to 0.125 inches (0.32 cm), greater than or equal to 0.50 inches (1.27 cm), greater than or equal to 1 inch (2.54 cm), or even greater than or equal to 2 inches (5.08 cm). In embodiments, the difference between the distributor width W_{D} of the chemical feed distributors 120 and the slot width W_{S} of each of the slots 216 may be from 0.125 inches to 15 inches, 0.5 inches to 13 inches, 1.0 inches to 10 inches, or even from 2 inches to 8 inches.

In embodiments, the slot widths W_{S} may be the same for all of the slots 216 of the intermediate beams 210. In embodiments, the slot width W_{S} may change based on the position of the slots 216 along the length of the intermediate beam 210. In embodiments in which one of the first end 212 or second end 214 of the intermediate beam 210 is rigidly and fixedly coupled to the vessel wall 104, the slot width W_{S} of the slot 216 nearest the fixed end of the intermediate beams 210 may have an initial slot width and the slot widths W_{S} of each successive slot 216 further from the fixed end of the intermediate beams 210 may increase to accommodate thermal expansion of the intermediate beams 210. Referring to FIG. 6, in embodiments, both the first end 212 and the second end 214 of the intermediate beams 210 may be slidably coupled to the vessel wall 104. In these circumstances, the slots 216 closest to a horizontal center 221 of the intermediate beams 210 may have the smallest slot width W_{S} and the slot widths W_{S} of each successive slot outward from the horizontal center 221 may have successively greater slot widths W_{S}. In this case, the slots closest to the first end 212 and second end 214 may have the greatest slot width W_{S}.

FIG. 5 illustrates an embodiment of the intermediate beams 210 in which the first end 212 of the intermediate beams 210 is fixed to the vessel wall 104 and the second end 214 is slidably coupled to the vessel wall 104. As illustrated in FIG. 5, the slot 216 closest to the first end 212 may have the least slot width W_{S} and each successive slot 216 in the −Y direction in FIG. 5 may have a greater slot width W_{S} than the previous adjacent slot 216. Thus, the slot width W_{S} may increase with increasing position in the −Y direction along the intermediate beam 210. The intermediate beam 210 in FIG. 5 is shown at ambient temperatures, and the dimensions may be exaggerated for purposes of illustration. At ambient temperatures, the slots 216 may be positioned along the length of the intermediate beam 210 (e.g., in the +/−Y direction of the coordinate axis in FIG. 5) so that for each slot 216, the side surface 226 furthest from the first end 212 of the intermediate beams 210 is closely fit to the outermost surface of the chemical feed distributor 120, and the side surface 226 closest to the first end 212 of the intermediate beams 210 is spaced apart from the chemical feed distributor 120 to form a gap G_{S} between the side surface 226 of the slot 216 and the chemical feed distributor 120. This gap G_{S} may increase for each successive slot 216 in the −Y direction of the coordinate axis in FIG. 5. When the temperature of the intermediate beams 210 is increased to the operating temperature of the fluidized bed processing system 100, the intermediate beams 210 may thermally expand in the −Y direction of FIG. 5. The successively increasing gaps G_{S} may allow the intermediate beam 210 to thermally expand in the −Y direction without contacting the chemical feed distributors and displacing the chemical feed distributors in the −Y direction. FIG. 5 illustrates an example in which the first end 212 is fixed and the second end 214 (FIG. 3) is slidable relative to the vessel wall 104. However, it is understood that the second end 214 of the intermediate beams 210 could be fixed to the vessel wall 104, the first end 212 can be slidable relative to the vessel wall 104, and the slots 216 could be positioned and configured to accommodate thermal expansion of the intermediate beams 210 from the second end 214 toward the first end 212 (e.g., in the +Y direction).

Referring now to FIG. 6, an embodiment in which both the first end 212 and the second end 214 of the intermediate beam 210 are slidably coupled to the vessel wall 104 is schematically depicted. As illustrated in FIG. 6, the slots 216 closest to the horizontal center 221 of the intermediate beam 210 may have the least slot width W_{S} and each successive slot 216 outward toward the first end 212 and second end 214 may have a greater slot width W_{S} compared to each previous adjacent slot 216. Thus, the slot width W_{S} may increase with increasing distance in the +/−Y direction from the horizontal center 221 of the intermediate beam 210. The intermediate beam 210 in FIG. 6 is shown at ambient temperatures, and the dimensions may be exaggerated for purposes of illustration. At ambient temperatures, the slots 216 may be positioned along the length L of the intermediate beam 210 (e.g., in the +/−Y direction of the coordinate axis in FIG. 65) so that, for each slot 216, the side surface 226 furthest from the horizontal center 221 of the intermediate beam 210 may be closely fit to the outermost surface of the chemical feed distributor 120, and the side surface 226 closest to the horizontal center 221 of the intermediate beams 210 is spaced apart from the chemical feed distributor 120 to form the gap G_{S} between an side surface 226 of the slot 216 and the chemical feed distributor 120. This gap G_{S} may increase for each successive slot 216 further away from the horizontal center 221. When the temperature of the intermediate beam 210 is increased to the operating temperature of the fluidized bed processing system 100, the intermediate beam 210 may thermally expand from the horizontal center 221 of the intermediate beam 210 outward in both the +Y and −Y directions of FIG. 6. The successively increasing gaps G_{S} may allow the intermediate beam 210 to thermally expand in outward from the horizontal center 221 without contacting the chemical feed distributors 120 and displacing the chemical feed distributors 120 in the +/−Y directions.

Various forces may act on the chemical feed distributors 120 to move them in the vertical direction. These forces may include contact with air or solid catalyst particles moving vertically through the fluidized bed processing system 100, the forces caused by flow of the chemical feed exiting the plurality of outlets in each of the chemical feed distributors 120, or other forces. Referring to FIGS. 3-6, the intermediate beams 210 may restrict movement of the chemical feed distributors 120, which are disposed through the slots 216, in the vertical direction (i.e., the +/−Z direction of the coordinate axis of FIGS. 3-6) through contact of the upper surfaces 222 and lower surfaces 224 of the slots 216 with the chemical feed distributors 120 to counteract these forces. Reducing vertical movement of the chemical feed distributors 120 may reduce stress on the chemical feed distributors 120 where they connect to the vessel wall 104, thereby reducing or prevent mechanical failure of the chemical feed distributors 120 and extending the service life. The lateral clearance (e.g. clearance in the +/−Y direction of the coordinate axis in FIGS. 3-6) between the side surfaces 226 of the slots 216 and the chemical feed distributors 120 may allow for thermal expansion of the intermediate beams 210 without displacing the chemical feed distributors in the +/−Y direction.

Referring again to FIGS. 4-6, the chemical feed distributors 120 may include reinforcing bars 132 rigidly coupled to the outer surface of the distributor walls 126 at the points where the chemical feed distributors 120 are most likely to contact the intermediate beams 210. The reinforcing bars 132 may be positioned to contact the inner surfaces (i.e., upper surface 222, lower surface 224, and/or side surfaces 226) of the slots 216 of the intermediate beams 210 when the chemical feed distributors 120 are disposed in the slots 216. The reinforcing bars 132 may be coupled to the outer surface of the distributor walls 126 along an entire length of the chemical feed distributor 120 or along only along portions of the length of the chemical feed distributor 120 that can contact with the intermediate beams 210. The reinforcing bars 132 may reduce or prevent damage to the chemical feed distributor 120 due to contact with the intermediate beams 210. Each chemical feed distributor 120 may include the reinforcing bars 132 on the vertical top and bottom of the distributor walls 126 where the chemical feed distributor 120 can contact the intermediate beams 210. The top and bottom of each chemical feed distributor 120 is most likely to contact the upper surface 222 and/or lower surface 224 of the slots 216 of the intermediate beams 210 due to the reduced clearance to restrict vertical movement of the chemical feed distributors 120. In embodiments, the chemical feed distributors 120 may also have reinforcing bars 132 on the lateral sides of the chemical feed distributors 120 to reduce or prevent damage to the sides of the chemical feed distributors 120 caused by contact of the sides with the side surfaces 226 of the slots 216 of the intermediate beams 210.

The distributor support system 200 may include one or a plurality of intermediate beams 210 to vertically support the plurality of chemical feed distributors 120. In embodiments, the distributor support system 200 may include 1, 2, 3, 4, or more than 4 intermediate beams 210. Referring to FIG. 2, in embodiments, the fluidized bed processing systems 100 may include two or more subsets of chemical feed distributors 120 and each subset of chemical feed distributors 120 may be engaged with the slots 216 of one or a plurality of the intermediate beams 210. Referring again to FIG. 2, the fluidized bed processing systems 100 may include a first plurality of chemical feed distributors 120 and at least one first intermediate beam 210, where the first plurality of chemical feed distributors 120 may be coupled to a first side of the vessel wall 104 and may extend through the slots 216 in the at least one first intermediate beam 210. The fluidized bed processing systems 100 may further include a second plurality of chemical feed distributors 120 and at least one second intermediate beam 210, the second plurality of chemical feed distributors 120 may be coupled to a second side of the vessel wall 104 opposite the first side and the second plurality of chemical feed distributors 120 may extend through the slots 216 in the at least one second intermediate beam 210. The chemical feed distributors 120 and intermediate beams 210 in FIG. 2 may have any of the features previously described in the present disclosure for the chemical feed distributors 120 and intermediate beams 210, respectively.

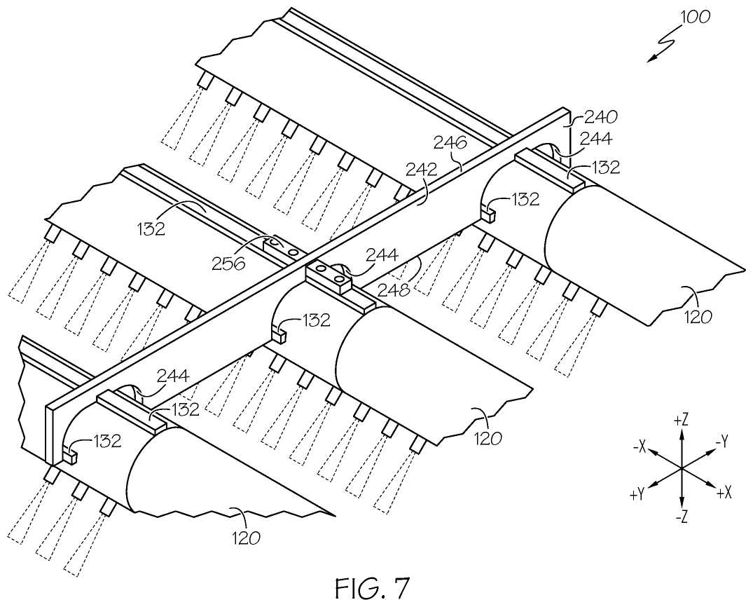

Referring now to FIG. 7, the distributor support system 200 may include one or more lateral guides 240 that may restrict and/or reduce lateral displacement (e.g., displacement in the +/−Y direction of the coordinate axis in FIG. 7) of the chemical feed distributors 120, which may reduce or prevent stress at the connection of the chemical feed distributors 120 with the vessel wall 104. Each lateral guide 240 may interconnect two or more chemical feed distributors 120 to provide lateral support to the two or more chemical feed distributors 120. Each lateral guide 240 may comprise a flat bar 242 having a plurality of cutouts 244 disposed on a long end of the flat bar 242. The flat bar 242 may be a rectangular bar having an upper end 246 and a lower end 248. The upper end 246 or the lower end 248 may include the plurality of cutouts 244. Each lateral guide 240 may include 2, 3, 4, or more than 4 cutouts 244. Each of the plurality of cutouts 244 may be an open-sided slot and may be shaped to receive at least a portion of a chemical feed distributor 120. As shown in FIGS. 7-9, in embodiments, the cutouts 244 may be disposed in the lower end 248 of the lateral guide 240 so that the lateral guide 240 is positioned on top of the chemical feed distributors 120. However, it is understood that, in embodiments, the plurality of cutouts 244 may be disposed in the upper end 246 of the lateral guide 240 so that the lateral guide is positioned underneath the chemical feed distributors 120.

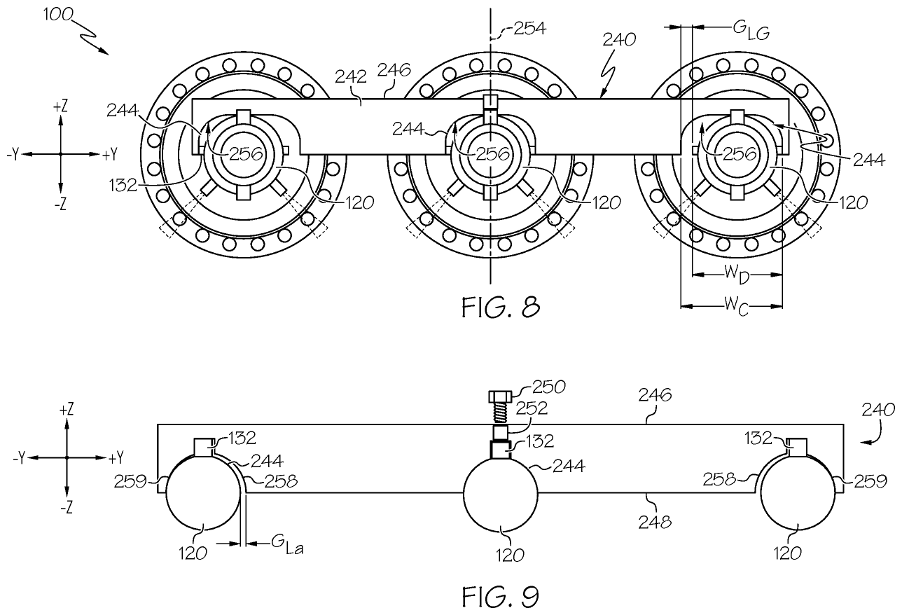

Referring to FIG. 8, as previously discussed, each of the plurality of cutouts 244 in the lateral guide 240 may be shaped to receive one of the chemical feed distributors 120. Referring to FIG. 8, in embodiments, each of the plurality of cutouts 244 may have a shape that accommodates the contour of a portion of the outer surface of the chemical feed distributors 120, which may include the one or more reinforcing bars 132 coupled to the outer surface of the chemical feed distributors 120 at positions expected to contact the lateral guide 240. Referring to FIG. 9, the cutouts 244 may be shaped to mirror the contour of at least a portion of the outer surface of the chemical feed distributors 120 without the reinforcing bars 132 on the lateral sides of the distributor walls 126. In embodiments, each of the cutouts 244 may be shaped to receive half of the chemical feed distributor 120 within the cutout 244. At ambient conditions, one or more of the plurality of cutouts 244 may have a cutout width W_{C} that is greater than the distributor width W_{D} to allow for thermal expansion of the lateral guide 240 in the +/−Y direction and for thermal expansion of the chemical feed distributors in the +/−X direction of the coordinate axis in the figures when the fluidized bed processing system 100 is heated to the greater operating temperatures. The cutout width W_{C} may be small enough so that the lateral guide 240 is effective at restricting lateral movement of the chemical feed distributors 120, such as movement in the +/−Y direction of the coordinate axis in the Figures.

Referring to FIGS. 7-9, each lateral guide 240 may be engaged with a subset of the plurality of chemical feed distributors 120 so that each cutout 244 receives at least a portion of one of the chemical feed distributors 120. The lateral guide 240 may be rigidly coupled to one of the chemical feed distributors 120 at one of the plurality of cutouts 244. The lateral guide 240 may be rigidly coupled to the one chemical feed distributor 120 by welding, brazing, adhering, or fastening the lateral guide 240 to the one chemical feed distributor 120, such as to a reinforcing bar 132 coupled to the outer surface of the distributor wall of the chemical feed distributor 120. In embodiments, the lateral guide 240 may be rigidly coupled to the one chemical feed distributor 120 by one or a plurality of fasteners 250, such as one or more bolts, screws, clips, pins, straps, other fasteners, or combinations of these. In embodiments, the lateral guide 240 may include a fastener bar 252 rigidly coupled to the lateral guide 240. The fastener bar 252 may provide for a plurality of fasteners 250 to rigidly couple the lateral guide 240 to the one chemical feed distributor 120. The lateral guide 240 may be coupled to the one chemical feed distributor 120 at any single one of the cutouts 244. In embodiments in which the lateral guide 240 includes three or more cutouts 244, the lateral guide 240 may be rigidly coupled to the one chemical feed distributor 120 at a cutout 244 in the middle portion of the lateral guide 240, such as a cutout 244 proximate the horizontal center 254 of the lateral guide 240.

The other chemical feed distributors 120 in the subset may be received in the cutouts 244 of the lateral guide 240 but not rigidly coupled to the lateral guide 240 to allow the lateral guide 240 to thermally expand and contract in the +/−Y direction in response to changes in temperature during operation. At ambient temperature, the one cutout 244 at which the lateral guide 240 is rigidly coupled to the one chemical feed distributor 120 may be closely fit to the outer dimensions of the one chemical feed distributor 120. A difference between the cutout width W_{C} of the cutout 244 at which the lateral guide 240 is rigidly coupled to the one chemical feed distributor 120 and the distributor width W_{D} of the one chemical feed distributor may be less than or equal to 0.25 inches (1.27 centimeters (cm)), less than or equal to 0.20 inches (0.51 cm), less than or equal to 0.125 inches (0.32 cm), or even less than or equal to 0.06125 inches (0.16 cm), at ambient temperatures.

Referring to FIG. 9, at ambient temperature, the cutouts 244 that are not rigidly coupled to the one chemical feed distributor 120 may have a cutout width W_{C} that allows for greater thermal expansion of the lateral guide 240. Each of the cutouts 244 not rigidly coupled to the one chemical feed distributor 120 may have an inner cutout surface 256 having a proximal side 258 and a distal side 259. The proximal side 258 may be the side of the cutout 244 that is closest to the cutout 244 that is coupled to the one chemical feed distributor 120, and the distal side 259 may be the side of the cutout 244 that is farthest from the cutout 244 that is coupled to the one chemical feed distributor 120. For the cutouts 244 not rigidly coupled to the one chemical feed distributor 120 at ambient temperatures, the distal side 259 of the cutout 244 may be closely fit to the side of the chemical feed distributor 120 disposed in the cutout 244, and the proximal side 258 may be spaced apart from the other side of the chemical feed distributor 120 to form a cutout gap G_{C} between the proximal side 258 and the chemical feed distributor 120. The cutout gap G_{C} at the proximal side 258 of the cutout 244 may allow for thermal expansion of the lateral guide 240 outward (e.g., in the +/−Y direction of the coordinate axis in FIGS. 7-9) from the cutout 244 that is rigidly coupled to the one chemical feed distributor 120. At ambient temperatures, the cutout gap G_{C} between the proximal side 258 and the chemical feed distributor 120 may be from 0.125 inches to 0.325 inches. If the cutout gap G_{C} is less than 0.125 inches at ambient temperatures, then thermal expansion of the lateral guide 240 at the operating conditions of the fluidized bed processing system 100 may cause lateral displacement of one or more of the chemical feed distributors 120 engaged therewith, which can lead to stress at the connection of the chemical feed distributors 120 to the vessel wall 104. If the cutout gap G_{C} is greater than 0.325 inches at ambient temperatures, then the lateral guide 240 may not be effective to reduce lateral displacement of the chemical feed distributors 120 caused by other external forces at the operating temperatures of the fluidized bed processing system 100.

Referring again to FIGS. 7-9, the lateral guide 240 may operate to interconnect a subset of chemical feed distributors 120 to restrict lateral movement (i.e., movement in the X-Y plane of the coordinate axis in FIGS. 7-9) of each of the chemical feed distributors 120 relative to the others in the subset. Various forces may act on the chemical feed distributors 120 to move them in the lateral direction, such as the +/−Y direction of the coordinate axis in the figures. These forces may include but are not limited to forces caused by expansion of liquid water exiting one or more outlets in the chemical feed distributors 120, air bubbles exiting one or more outlets in the chemical feed distributors 120, or other forces. Referring to FIGS. 7-9, the lateral guides 240 may restrict movement of the chemical feed distributors 120 in the lateral direction (i.e., the +/−Y direction of the coordinate axis of FIGS. 7-9) through contact of the inner cutout surfaces 256 of the cutouts 244 in the lateral guide 240 with the chemical feed distributors 120 to counteract these forces. Reducing lateral displacement of the chemical feed distributors 120 may reduce stress on the chemical feed distributors 120 at the inlet where they connect to the vessel wall 104, thereby extending the service life of the chemical feed distributors 120.

The distributor support system 200 may include a plurality of lateral guides 240. In embodiments, each of the plurality of lateral guides 240 may be engaged with a discrete subset of chemical feed distributors 120 that is separate from the subsets of chemical feed distributors 120 engaged with other lateral guides 240. In embodiments, one or more of the lateral guides 240 may overlap with each other so that one or more than one chemical feed distributors 120 may be engaged with two or more lateral guides 240.

A plurality of lateral guides 240 may be installed to provide lateral support to the chemical feed distributors 120 at a plurality of positions along the lengths of the chemical feed distributors (e.g., +/−X positions in the coordinate axis of the Figures.) Referring to FIGS. 2 and 7, in embodiments, one or more lateral guides 240 may be positioned between the intermediate beams 210 and the closest side of the vessel wall 104 to the intermediate beams 210. Referring to FIGS. 2 and 10, in embodiments, one or more lateral guides 240 may be positioned proximate the terminal ends 130 of the plurality of chemical feed distributors 120. In this configuration, the intermediate beam 210 is positioned between the lateral guides 240 and the closest side of the vessel wall 104. Positioning one or more lateral guides 240 at the terminal ends 130 of the chemical feed distributors 120 may stabilize the terminal ends 130 of the chemical feed distributors 120 and reduce lateral displacement of the terminal ends 130.

Referring to FIG. 10A, the lateral guides 240 may be positioned proximate the terminal ends 130 of the chemical feed distributors 120 to act as end guides to stabilize the terminal ends 130 of the chemical feed distributors 120. Referring to FIG. 10B, when one or more of the lateral guides 240 are disposed proximate the terminal ends 130 of the chemical feed distributors 120, the lateral guides 240 may conduct additional heat into the terminal ends 130 of the chemical feed distributors 120. The combination of this additional heat and the reduced flow of chemical feed at the terminal ends 130 of the chemical feed distributors 120 may cause the temperatures at the terminal ends 130 of the chemical feed distributors 120 to increase, which may result in additional coking and plugging of outlets at the terminal ends 130 of the chemical feed distributors 120. To reduce the effects of the lateral guides 240 on heating the terminal ends 130 of the chemical feed distributors 120, in embodiments, each of the chemical feed distributors 120 may include an insulating material 160 disposed inside the terminal ends 130 of the chemical feed distributors 120. The insulating material 160 may be positioned at least at the location where the lateral guide 240 engages with the chemical feed distributor 120. The insulating material 160 may be isolated from the chemical feed in the chemical feed distributor 120 by a partition 162. The insulating material 160 may reduce or prevent conduction of heat from the lateral guides 240 to the chemical feed in the chemical feed distributors 120.

Referring now to FIG. 11, in embodiments, the distributor support system 200 may include one or a plurality of end guides 270 engaged with the terminal ends 130 of the chemical feed distributors 120. The end guides 270 may be used in addition to or as an alternative to lateral guides 240 that are positioned proximate the terminal ends 130 of the chemical feed distributors 120. The end guides 270 may restrict lateral movement of the chemical feed distributors 120 in the +/−Y direction of the coordinate axis of FIGS. 11-13 while still allowing each of the chemical feed distributors 120 to thermally expand to different degrees in the +/−X direction.

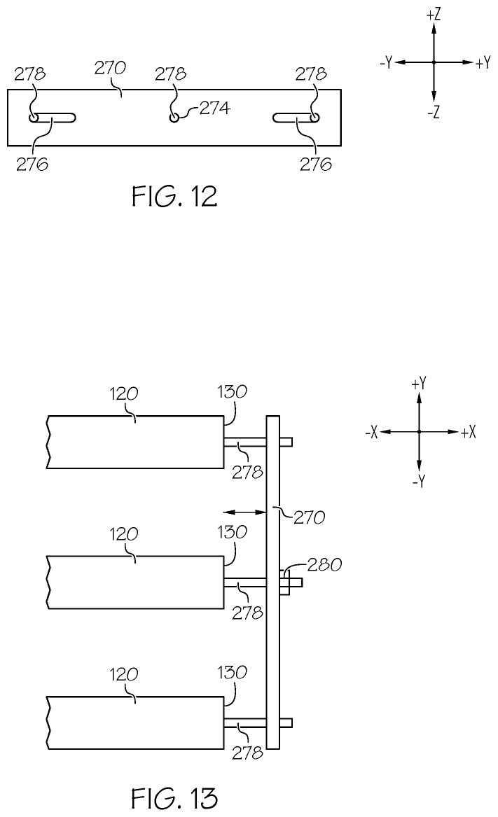

Referring now to FIG. 12, the end guides 270 may each comprise a flat bar 272 having one mounting hole 274 and one or a plurality of slots 276 spaced apart from the mounting hole 274. Each end guide 270 may have 1, 2, 3, or more than three slots 276. Each end guide 270 may have n−1 slots 276, where n is equal to the number of chemical feed distributors 120 in the subset of chemical feed distributors 120 to which the end guide 270 is engaged. Referring to FIG. 13, the terminal end 130 of each of the chemical feed distributors 120 may include a rod 278 protruding outward from the terminal end 130 in the +/−X direction of the coordinate axis in FIG. 13. Referring to FIGS. 11-13, the rod 278 of one of the chemical feed distributors 120 may be disposed through the hole 274 of the end guide 270, and the end guide 270 may be coupled to the one chemical feed distributor 120 engaged with the hole 274 with a fastener 280, such as but not limited to bolts, screws, clips, pins, straps, other fasteners, or combinations of these. The rods 278 of each of the other chemical feed distributors 120 in the subset may be received in the slots 276 of the end guide 270. The slots 276 may allow for thermal expansion of the end guides 270 without laterally displacing the chemical feed distributors 120 in the +/−Y direction when the fluidized bed processing system 100 is increased to its operating temperature. In embodiments, the rods 278 disposed through the slots 276 may, optionally, include a fastener 280, such as but not limited to a bolt, clip, pin, strap, other fastener, or combinations of these, which may prevent the rod 278 from disengaging from the slot 278 during operation of the fluidized bed processing system 100.

Referring to FIG. 11, the end guide 270 may be spaced apart from the terminal end 130 of each of the chemical feed distributors 120, and each of the rods 278 may be slidable within the hole 274 or slot 276 through which it is disposed, which may allow for differences in thermal expansion of the chemical feed distributors 120 during operation. For example, when a chemical feed distributor 120 becomes plugged due to coke formation or other reasons, the flow of chemical feed may cease, which reduces the cooling effect of the flow of chemical feed on the chemical feed distributors 120. The reduced cooling by the chemical feed may cause the temperature of the plugged chemical feed distributor 120 to increase, thereby increasing the thermal expansion in the +/−X direction of the plugged chemical feed distributor 120 relative to the other chemical feed distributors 120 that are not plugged. Spacing the end guide 270 apart from the terminal ends 130 of the chemical feed distributors 120 may allow the rods 278 to slide in the +/−X direction relative to the end guide 270 to compensate for these differences in thermal expansion of the chemical feed distributors 120. Engagement of the rods 278 of the chemical feed distributors 120 with the hole 274 and slots 276 of the end guide 270 may restrict lateral displacement of the chemical feed distributors 120 in the +/−Y direction while still allowing for thermal expansion of both the end guides 270 and the chemical feed distributors 120.

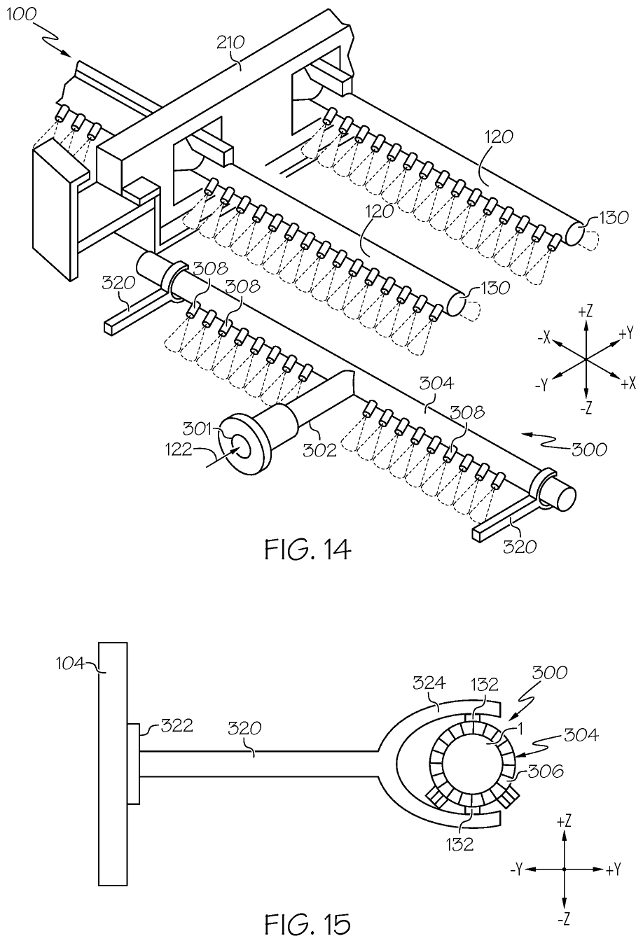

Referring now to FIGS. 2 and 14, attachment of the intermediate beams 210 to the vessel wall 104 may create an area within the vessel 102 that is not accessible to the chemical feed distributors 120. This area may create a dead zone where no chemical feed is introduced to the vessel 102, which may reduce the utilization and capacity of the fluidized bed processing system 100. In embodiments, the fluidized bed processing system 100 may include one or a plurality of T-distributors 300 disposed in the areas of the vessel 102 blocked by attachment of the intermediate beams 210 to the vessel wall 104. Each T-distributor 300 may comprise a chemical feed inlet 301. The chemical feed inlet 301 may introduce the chemical feed stream 122 into the T-distributor 300. The chemical feed stream 122 may pass through the chemical feed inlet 301 into the T-distributor 300. The chemical feed inlet 301 may refer to a place of entry in the vessel 102 that allows the T-distributor 300 and the chemical feed stream 122 within the T-distributor 300 to pass through the vessel wall 104 and into the internal volume of the vessel 102. The T-distributor 300 may be coupled to the vessel wall 104 proximate the chemical feed inlet 301.

The T-distributor 300 may include an inlet conduit 302 in fluid communication with the chemical feed inlet 301 and a distribution conduit 304 in fluid communication with the inlet conduit 302. The distribution conduit 304 may be oriented orthogonal to the inlet conduit 302 to form a T-shape. The inlet conduit 302 may operate to pass the chemical feed 122 from the chemical feed inlet 301 of the T-distributor 300 to the distributor conduit 304. The inlet conduit 302 may not have any chemical feed outlets along its length between the chemical feed inlet 301 and the distribution conduit 304. The distribution conduit 304 may include a T-distributor body 305 comprising one or more walls 306. The one or more walls 306 may define an elongated chemical feed stream flow path therethrough.

The T-distributor body 305 of the distribution conduit 304 may include a plurality of chemical feed outlets 308, which may be openings in the one or more walls 306 of the body 305. The plurality of chemical feed outlets 308 may be spaced along at least a portion of a length of the distribution conduit 304. In embodiments, the plurality of chemical feed outlets 308 may be arranged in a singular row along the distribution conduit 304 of the T-distributor 300. In other embodiments, the plurality of chemical feed outlets 308 may be arrange in alternating positions along the distribution conduit 304 of the T-distributor 300, such as two rows. It is contemplated that the chemical feed outlets 308 may be arrange in any configuration along the distribution conduit 304 of the T-distributor 300.

The chemical feed outlets 308 may provide a passage for the chemical feed stream 122 from the T-distributor 300 into the internal volume of the vessel 102. The plurality of chemical feed outlets 308 may be operable to pass portions of the chemical feed stream 122 out of the T-distributor 300 and into the internal volume of the vessel 102. Each of the plurality of chemical feed outlets 308 may include an orifice and, optionally, a diffuser, as previously described in relation to the chemical feed distributors 120 depicted in FIG. 18. The chemical feed outlets 308 may have any of the features previously described for the chemical feed outlets 124 of the chemical feed distributors 120 described and shown in FIG. 18.

The one or more walls 126 may define an elongated chemical feed stream flow path 127. The plurality of chemical feed outlets 124 may be spaced along at least a portion of the length of the elongated chemical feed stream flow path 127. Individual ones of the plurality of chemical feed outlets 124 may be operable to pass portions of the chemical feed stream 122 out of the chemical feed distributor 120 and into a vessel 102. The total flow rate of the chemical feed stream 122 entering the chemical feed distributor 120 may be equal to the flow rate of the portions of the chemical feed stream 122 passing through individual ones of the plurality of chemical feed outlets 124 and into the vessel 102.

Referring to FIGS. 14 and 15, the distributor support system 200 may further include one or a plurality of supports 320 operable to provide support for each side of the distribution conduit 304 of each T-distributor 300. Each of the supports 320 may be coupled to the vessel wall 104 at an attachment end 322 of the support 320. A support end 324 of the support 320 may be shaped to engage with a top surface and a bottom surface of the distribution conduit 304 to provide vertical support to the distribution conduit 304. In embodiments, the support end 324 of the support 320 may be forked, as shown in FIG. 15. Referring to FIG. 15, in embodiments the distribution conduit 304 of the T-distributor 300 may include one or more reinforcing bars 132 coupled to an outer surface of the distribution conduit 304 at positions where the distribution conduit 304 contacts the supports 320.

Referring again to FIG. 2, when the vessel 102 has an internal diameter of greater than or equal to 15 feet (4.6 meters), the increased length of each of the chemical feed distributors 120 may result in maldistribution of the chemical feed due to increased temperature and decreased pressure of the chemical feed proximate the terminal ends 130 of the chemical feed distributors 120. For example, during operation of the fluidized bed processing system 100, the chemical feed stream 122 may be fed at a relatively cool temperature compared to the temperature inside the vessel 102. According to embodiments, the differential between the temperature of the chemical feed stream 122 and the temperature inside the vessel 102 may greater than 300° C., such as greater than 350° C., greater than 400° C., greater than 450° C., greater than 500° C., greater than 550° C., greater than 600° C., or greater than 650° C.

In embodiments, the temperature inside the vessel 102 may be greater than 500° C. and the temperature of the chemical feed stream 122 may be less than the temperature inside the vessel 102. During operation, the temperature inside the vessel 102 may heat the chemical feed distributor 120 and, therefore, may increase the circumferential maximum surface temperature of the chemical feed distributor 120. Circumferential maximum surface temperature may refer to the highest surface temperature throughout the chemical feed distributor 120. Heat from the vessel 102 may also increase the temperature of the chemical feed stream 122 within the chemical feed distributor 120. If the circumferential maximum surface temperature of the chemical feed distributor 120 or the temperature of the chemical feed stream 122 inside the chemical feed distributor 120 increases too much, the chemical feed stream 122 may begin to deposit coke on the chemical feed distributor 120. When coke deposits on the chemical feed distributor 120, plugging may occur at the plurality of chemical feed outlets 124, which can result in flow maldistribution leading to operational issues. As used in the present disclosure, “flow maldistribution” may refer to differences in uniform flow distribution between the individual ones of the plurality of chemical feed outlets 124.

Referring now to FIG. 16, in embodiments, the chemical feed distributors 120 of the present disclosure may have a cross-sectional area that changes along the length of the chemical feed distributor 120 in order to maintain sufficient linear gas velocity of the chemical feed 122 proximate the terminal end 130 of the chemical feed distributor 120. In other words, each chemical feed distributor 120 may have a smaller cross-sectional area proximate the terminal end 130 compared to the cross-section area of the chemical feed distributor 120 proximate the chemical feed inlet 121. As used herein in relation to the chemical feed distributors 120, the term “cross-sectional area” of the chemical feed distributor refers to the area of the two-dimensional shape defined by the inner surface of the distributor wall 126 formed by passing a transverse plane through the chemical feed distributor 120 at any given point. The “average cross-sectional area” of the chemical feed distributor 120 is the average of the cross-sectional area taken over a specified length of the chemical feed distributor 120. As the chemical feed stream 122 passes from the chemical feed distributor 120 through the plurality of chemical feed outlets 124 and into the vessel 102, the flow rate of the chemical feed stream 122 in the chemical feed distributor 120 may be maintained or at least less affected due to the decreasing cross-sectional area along the length of the chemical feed distributor 120.

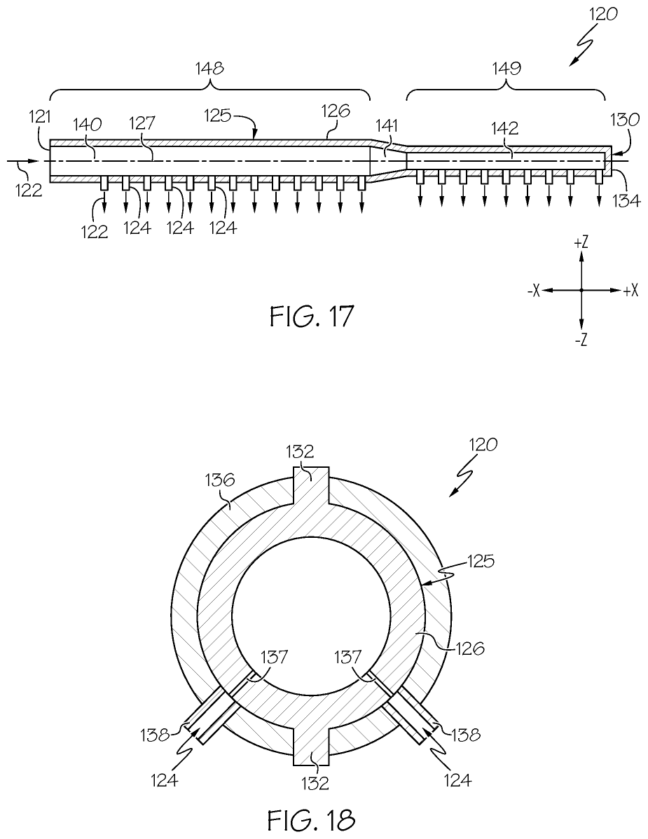

Referring to FIG. 17, one embodiment of a chemical feed distributor 120 having a cross-sectional area that changes based on the position along the length of the chemical feed distributor 120 (e.g., position in the +/−X direction of the coordinate axis in FIG. 17) is schematically depicted. As previously discussed, each chemical feed distributor 120 may include a distributor wall 126. Each chemical feed distributor 120 may also include an end wall 134 disposed at the terminal end 130 of the chemical feed distributor 120. In embodiments, the distributor wall 126 may define a first pipe 140, a frustum-shaped transition section 141, and a second pipe 142. As used herein, a pipe may refer to a cylindrical conduit having any cross-sectional shape. For example, a pipe may have a cross-sectional shape that is circular, oval, rectangular, polygonal, irregular-shaped, or any other shape. The first pipe 140 may be in contact with and downstream from the chemical feed inlet 121. The frustum-shaped transition section 141 may be in contact with and downstream from the first pipe 140. The second pipe 142 may be in contact with and downstream from the frustum-shaped transition section 141. Together, the first pipe 140, a frustum-shaped transition section 141, and the second pipe 142 may define the elongated chemical feed stream flow path 127. The plurality of chemical feed outlets 124, as detailed above, may be spaced along a portion of the length of the elongated chemical feed stream flow path 127, or, alternatively, along a portion of the first pipe 140, the frustum-shaped transition section 141, and the second pipe 142. Therefore, the chemical feed stream 122, after entering the chemical feed distributor 120 via the chemical feed inlet 121, may pass along the elongated chemical feed stream flow path 127 and may pass out of the chemical feed distributor 120 via the plurality of chemical feed outlets 124.

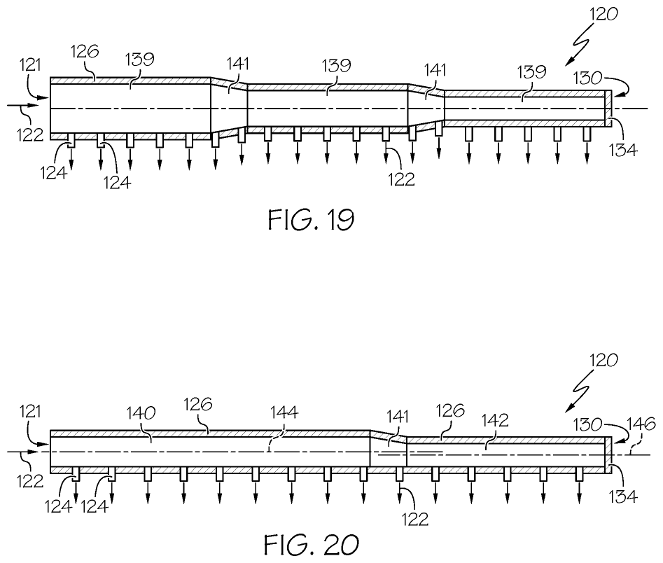

While FIG. 17 depicts a chemical feed distributor 120 comprising first pipe 140, a frustum-shaped transition section 141, and a second pipe 142, it is contemplated that the chemical feed distributor 120 may include any number of pipes (i.e., pipe segments) and frustum-shaped transition sections 141. For example, the chemical feed distributor 120 may comprise a plurality of pipe segments, such as, three, four, five, six, or more than 6 pipe segments with frustum-shaped transition sections 141 between each of the pipe segments. Further, it should be noted that each pipe segment need not comprise the exact same length. That is, individual shaped pipe segments may be shorter or longer than other individual shaped pipe segments. While the first pipe 140 and second pipe 142 of FIG. 17 may be approximately the same length, it is contemplated that the first pipe 140 and second pipe 142 may be different lengths. In embodiments, the first pipe 140 may be shorter than the second pipe 142. In other embodiments, the first pipe 140 may be longer than the second pipe 142. Further, in some embodiments, the chemical feed distributor 120 may comprise more than two pipe segments (i.e., a first pipe 140 and a second pipe 142). For instance, as shown in FIG. 19, the chemical feed distributor may include three pipe segments 139 with the pipe segments 139 separated from each other by a frustum-shaped transition section 141.

Referring again to FIG. 17, the center axis of the first pipe 140 and the center axis of the second pipe 142 may be collinear and may both lie along the distributor centerline 128. That is, the cross-section of the distributor wall 126 at the first pipe 140 and the cross-section of the distributor wall 126 at the second pipe 142 may form concentric circles. In such embodiments, the frustum-shaped transition section 141 may be radially symmetric about the distributor center line 128. Referring to FIG. 20, the center axis 144 of the first pipe 120 and the center axis 146 of the second pipe 122 may not be collinear. That is, the cross section of the distributor wall 126 at the first pipe 140 and the cross-section of the distributor wall 126 at the second pipe 142 may form non-centric circles. In such embodiments, the frustum-shaped transition section 141 may not be radially symmetric about an axis of the frustum-shaped transition section 141.

Referring again to FIG. 17, during operation of the chemical feed distributor 120, the chemical feed stream 122 may enter the chemical feed distributor 120 via the chemical feed inlet 121. The chemical feed stream 122 may be passed through the first pipe 140, the frustum-shaped transition section 141, and the second pipe 142. The elongated chemical feed stream flow path 127 may comprise an upstream fluid flow path portion 148 and a downstream fluid flow path portion 149. As the chemical feed stream 122 is passed along the elongated chemical feed stream flow path 127, portions of the chemical feed stream 122 may exit the chemical feed distributor 120 through the plurality of chemical feed outlets 124. As the portions of the chemical feed stream 122 exit the chemical feed distributor 120 through the plurality of chemical feed outlets 124, the linear gas velocity of the chemical feed stream 122 along the elongated chemical feed stream flow path 127 may decrease with increasing position in the +X dimension of the coordinate axis in FIG. 17. Reducing the average cross-sectional area of the chemical feed distributor 120 along the elongated chemical feed stream flow path 127 in the +X direction of the coordinate axis in FIG. 17 may compensate for the loss of volume to maintain the linear gas velocity of the chemical feed stream 122 or, alternatively, minimize the decrease in the linear gas velocity of the chemical feed stream 122. By maintaining the linear gas velocity or minimizing the decrease in the linear gas velocity, stagnation of the chemical feed stream 122 within the chemical feed distributor 120 may be decreased. By decreasing stagnation of the chemical feed stream 122, coking, and the side effects associated with coking, may also be decreased.

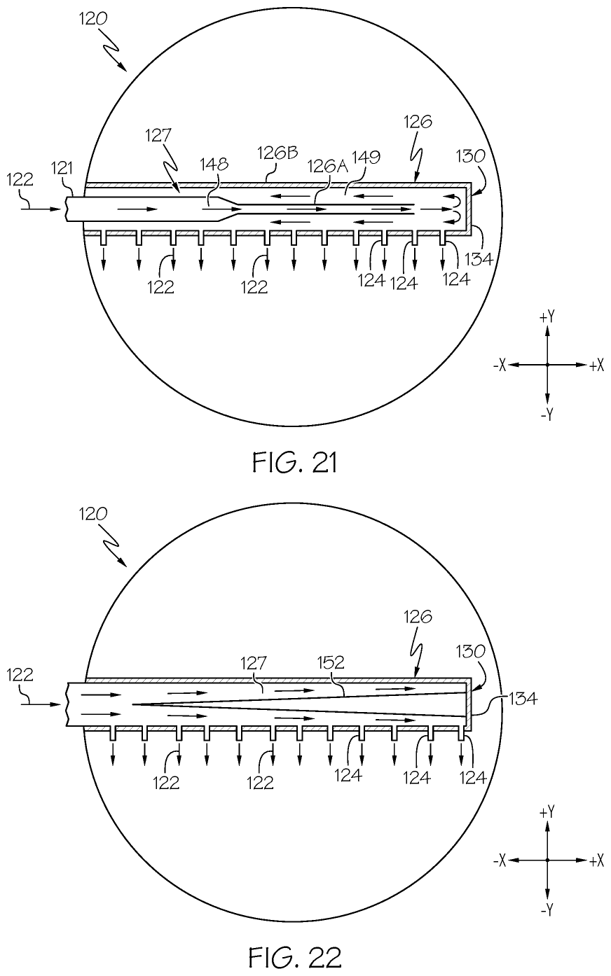

Now referring to FIG. 21, according to one or more embodiments, the distributor walls 126 may comprise a first wall 126A and a second wall 126B. The second wall 126B may have an inner diameter that is greater than a largest outer diameter of the first wall 126A. The second wall 126B may surround the first wall 126A. An inner surface of first wall 126A may define the upstream fluid flow path portion 148. An exterior surface of the first wall 126A and an interior surface of the second wall 126B may define the downstream fluid flow path portion 149. While the second wall 126B may comprise inner diameter greater than the largest external diameter of the first wall 126A, the downstream fluid flow path portion 149 may still comprise an average cross-sectional area that is less than the upstream fluid flow path portion 148. That is, while the average cross-sectional area of the second wall 126B may be greater than the first wall 126A, the downstream fluid flow path portion 148 may only be defined by the area not occupied by the upstream fluid flow path portion 149.

Still referring to FIG. 21, the downstream fluid flow path portion 149 of the elongated chemical feed stream flow path 127 may be an annular region defined between the first wall 126A and the second wall 126B and surrounding the upstream fluid flow path portion 148 of the elongated chemical feed stream flow path 127. The first wall 126A may define a first pipe 140. The second wall 126B may define a second pipe 142. The first pipe 140 and the second pipe 142 may comprise the same shaped pipes or may comprise different shaped pipes. The first wall 126A and the second wall 126B may form a co-axial geometry. It is also contemplated that the first wall 126A and the second wall 126B may form an eccentric geometry. The first wall 126A defining the upstream fluid flow path portion 148 of the elongated chemical feed stream flow path 127 may be hermetic such that the chemical feed stream 122 may not pass through the first wall 126A except where the first wall 126A ends and the upstream fluid flow path portion 148 of the elongated chemical feed stream flow path 127 is in fluid communication with the downstream fluid flow path portion 149 of the elongated chemical feed stream flow path 127. As shown in FIG. 21, the first wall 126A may be a shorter length than the second wall 126B such that the elongated chemical feed stream flow path 127 may be continuous through the chemical feed distributor 120.

Referring still to FIG. 21, during operation, the chemical feed stream 122 may enter the chemical feed distributor 120 via the chemical feed inlet 121. The chemical feed stream 122 may be passed through the upstream fluid flow path portion 148 of the elongated chemical feed stream flow path 127. As shown in FIG. 21, the first wall 126A defining the upstream fluid flow path portion 148 of the elongated chemical feed stream flow path 127 may terminate before the terminal end 130 of the chemical feed distributor 120 opposite the chemical feed inlet 121. This may allow the chemical feed stream 122 to continue from the upstream fluid flow path portion 148 of the elongated chemical feed stream flow path 127 to the downstream fluid flow path portion 149 of the elongated chemical feed stream flow path 127, as shown by the arrows in FIG. 21. As the chemical feed stream 122 travels along the downstream fluid flow path portion 149 of the elongated chemical feed stream flow path 127, the chemical feed stream 122 may travel back towards the chemical feed inlet 121, but on the outside of the first wall 126A, in the annular space defined between the first wall 126A and the second wall 126B. As the chemical feed stream 122 travels along the downstream fluid flow path portion 149 of the elongated chemical feed stream flow path 127, portions of the chemical feed stream 122 may exit the chemical feed distributor 120 through the plurality of chemical feed outlets 124. As portions of the chemical feed stream 122 exit the chemical feed distributor 120 through the plurality of chemical feed outlets 124, the linear gas velocity of the chemical feed stream 122 may decrease. However, as the average cross-sectional area along the downstream fluid flow path portion 149 of the elongated chemical feed stream flow path 127 decreases, the linear gas velocity of the chemical feed stream 122 may be maintained or, alternatively, the decrease in the linear gas velocity of the chemical feed stream 122 may be minimized. By maintaining the linear gas velocity or minimizing the decrease in the linear gas velocity, stagnation of the chemical feed stream 122 within the chemical feed distributor 120 may be decreased. By decreasing stagnation of the chemical feed stream 122, coking, and the side effects associated with coking, may also be decreased.

Now referring to FIG. 22, according to one or more embodiments, the chemical feed distributor 120 may comprise a chemical feed stream guide 152 disposed inside the distributor walls 126 of the chemical feed distributor 120. The chemical feed stream guide 152 may be in contact with the end wall 134 of the chemical feed distributor 120. At least a portion of the elongated chemical feed stream flow path 127 may be defined between an outer surface of the chemical feed stream guide 152 and the inner surface of the distributor walls 126. The chemical feed stream guide 152 may decrease the cross-sectional area of at least a portion of the elongated chemical feed stream flow path 127 along at least a portion of the length of the chemical feed distributor 120. In embodiments with the chemical feed stream guide 152, the distributor wall 126 of the chemical feed distributor 120 may have a constant size, such as a constant diameter for a circular cross-sectional shape, along the length of the chemical feed distributor 120. The chemical feed stream guide 152 may decrease the cross-sectional area of the elongated chemical feed stream flow path 127 along the length of the chemical feed distributor 120 without varying the diameter of the distributor wall 126 of the chemical feed distributor 120. However, it is contemplated that, according to one or more embodiments, the distributor wall 126 of the chemical feed distributor 120 may feature both a decreasing cross-sectional area defined by the inner surface of the distributor wall 126 (as in FIG. 17) in combination with a chemical feed stream guide 152 disposed inside the chemical feed distributor 120.

Referring still to FIG. 22, the average cross-sectional area of the chemical feed stream guide 152 may be greater in the downstream fluid flow path portion 149 compared to the average cross-sectional area in the upstream fluid flow path portion 148. It is also contemplated that, in embodiments, the chemical feed stream guide 152 may be located only in the downstream fluid flow path portion 149 of the chemical feed distributor 120. That is, in embodiments, the chemical feed stream guide 152 may not extend from the downstream fluid flow path portion 149 to the upstream fluid flow path portion 148. The chemical feed stream guide 152 may comprise any geometry. For example, the chemical feed stream guide 152 may have a conical shape, a frustoconical shape, a pyramidal shape, curvilinear shape, or other shape.

Referring still to FIG. 22, during operation, the chemical feed stream 122 may enter the chemical feed distributor 120 via the chemical feed inlet 121. The chemical feed stream 122 may be passed along the elongated chemical feed stream flow path 127. As the chemical feed stream 122 is passed along the elongated chemical feed stream flow path 127, portions of the chemical feed stream 122 may exit the chemical feed distributor 120 through the plurality of chemical feed outlets 124. Again, the linear gas velocity of the chemical feed stream 122 may decrease along the length of the chemical feed distributor 120 as the portions of the chemical feed stream 122 exit through the plurality of chemical feed outlets 124. However, the chemical feed stream guide 152 may reduce the cross-sectional area of the elongated chemical feed stream flow path 127 along the length of the chemical feed distributor 120. As the average cross-sectional area along the elongated chemical feed stream flow path 127 is reduced, the linear gas velocity of the chemical feed stream 122 may be maintained or, alternatively, the decrease in the linear gas velocity of the chemical feed stream 122 may be minimized. By maintaining the linear gas velocity or minimizing the decrease in the linear gas velocity, coking, and the side effects associated with coking, may also be decreased.

Referring to FIG. 18, the chemical feed distributor 120 may comprise a refractory material 136 lining the exterior of the distributor walls 126 of the chemical feed distributors 120. As used herein, a refractory material 136 is a material that may be resistant to decomposition by heat, pressure, or chemical attack, and may retain strength and form at high temperatures. Oxides of aluminum, silicon, magnesium, and calcium may be common materials used in the manufacturing of refractory materials. The refractory material 136 may be a thermal insulator with thermal conductivity less than approximately 14 W/m-K. According to one or more embodiments, the thickness of refractory material 136 lining the exterior of the distributor walls 126 defining the upstream fluid flow path portion 148 may be different from a thickness of the refractory material lining the exterior of the distributor walls 126 defining the downstream fluid flow path portion 149 of the elongated chemical feed stream flow path 127. For example, the thickness of refractory material 136 lining the downstream fluid flow path portion 149 of the elongated chemical feed stream flow path 127 may be greater than the thickness of refractory material 136 lining the walls 126 defining the upstream fluid flow path portion 148 of the elongated chemical feed stream flow path 127.

In embodiments, one or more of the plurality of chemical feed distributors 120 may include a first section and at least one second section along the longitudinal length of the chemical feed distributor 120, wherein the first section has a first diameter and the at least one second section has a second diameter different from the first diameter. In embodiments, the first diameter of the first section may be greater than the second diameter of the at least one second section, where the first section is proximate the chemical feed inlet relative to the at least one second section.

A first aspect of the present disclosure may be directed to a fluidized bed processing system that may comprise a vessel comprising a vessel wall and a plurality of chemical feed distributors coupled to the vessel wall and extending from the vessel wall into an internal volume of the vessel. Each of the chemical feed distributors may comprise a distributor body forming a chemical feed flow path and a plurality of chemical feed outlets distributed along a length of the distributor body. The fluidized bed processing system may further include at least one intermediate beam comprising at plurality of slots spaced apart along a beam length. The at least one intermediate beam may be coupled to the vessel wall at both ends. Each chemical feed distributors may pass through one slot of at least one intermediate beam. The at least one intermediate beam may provide vertical support for each of the plurality of chemical feed distributors.

A second aspect of the present disclosure may include the first aspect, wherein a difference between an outermost vertical dimension of each of the plurality of chemical feed distributors and a height of the slots in the at least one intermediate beam may be less than or equal to 0.25 inches.

A third aspect of the present disclosure may include either one of the first or second aspects, wherein a distributor centerline of each chemical feed distributor may deviate from a slot centerline of the slot through which the chemical feed distributor passes by less than 10% of an outermost vertical dimension of the chemical feed distributors.

A fourth aspect of the present disclosure may include any one of the first through third aspects, wherein the slots of the at least one intermediate beam may be aligned so that a slot centerline of the slots may be vertically aligned with a distributor centerline of each of the plurality of chemical feed distributors.

A fifth aspect of the present disclosure may include any one of the first through fourth aspects, wherein an outer surface of each chemical feed distributor may contact an upper surface or a lower surface of the slot in the intermediate beam through which the chemical feed distributor passes.

A sixth aspect of the present disclosure may include any one of the first through fifth aspects, wherein each chemical feed distributor may comprise one or more reinforcing bars coupled to an outer surface of the chemical feed distributor, wherein the one or more reinforcing bars may be positioned to contact an inner surface of the slot when the chemical feed distributor is disposed in the slot.

A seventh aspect of the present disclosure may include the sixth aspect, wherein the one or more reinforcing bars may contact the upper surface or the lower surface of the slot in the intermediate beam through which the chemical feed distributor passes.

An eighth aspect of the present disclosure may include any one of the first through seventh aspects, wherein a clearance between each of the plurality of chemical feed distributors and one or both side surfaces of the slot of the at least one intermediate beam may be sufficient to allow for thermal growth of the at least one intermediate beam without influencing or deflecting the lateral position of any of the plurality of chemical feed distributors.

A ninth aspect of the present disclosure may include any one of the first through eighth aspects, wherein a difference between a greatest horizontal dimension of the chemical feed distributor and a slot width of the slot may be greater than or equal to 0.125 inches or from 0.125 inches to 15 inches.

A tenth aspect of the present disclosure may include any one of the first through ninth aspects, wherein at least one end of the at least one intermediate beam may be slidable laterally relative to the vessel wall.

An eleventh aspect of the present disclosure may include any one of the first through tenth aspects, wherein slot widths of the slots may vary depending on the position of each slot along the length of the at least one intermediate beam.

A twelfth aspect of the present disclosure may include any one of the first through eleventh aspects, wherein a first end of the at least one intermediate beam may be rigidly coupled to the vessel wall and a second end of the at least one intermediate beam may be slidably coupled to the vessel wall.

A thirteenth aspect of the present disclosure may include the twelfth aspect, wherein slot widths of the slots may increase from the first end to the second end of the at least one intermediate beam.

A fourteenth aspect of the present disclosure may include any one of the first through eleventh aspects, wherein both ends of the at least one intermediate beam may be slidably coupled to the vessel wall.

A fifteenth aspect of the present disclosure may include the fourteenth aspect, wherein a slot width of the slots in the at least one intermediate beam may increase from a horizontal center of the at least one intermediate beam laterally outward towards each end of the at least one intermediate beam.

A sixteenth aspect of the present disclosure may include any one of the first through fifteenth aspects, comprising a first plurality of chemical feed distributors, at least one first intermediate beam, a second plurality of chemical feed distributors, and at least one second intermediate beam. The first plurality of chemical feed distributors may coupled to a first side of the vessel wall and extend through the slots in the at least one first intermediate beam. The second plurality of chemical feed distributors may be coupled to a second side of the vessel wall opposite the first side and the second plurality of chemical feed distributors extend through the slots in the at least one second intermediate beam.

A seventeenth aspect of the present disclosure may include any one of the first through sixteenth aspects, further comprising at least one lateral guide comprising a flat bar having a plurality of cutouts positioned along one side of the flat bar. Each of the at least one lateral guide may be engaged with a subset of the plurality of the chemical feed distributors, and each of the plurality of cutouts in the at least one lateral guide may receive at least a portion of one of the plurality of chemical feed distributors. The lateral guide may be rigidly coupled to one of the chemical feed distributors at least partially disposed in one of the plurality of cutouts.

An eighteenth aspect of the present disclosure may include the seventeenth aspect, wherein contact between the lateral guide and the portion of the chemical feed distributors received in the cutouts may restrict lateral movement of the chemical feed distributors.

A nineteenth aspect of the present disclosure may include either one of the seventeenth or eighteenth aspects, wherein the cutout at which the lateral guide is coupled to the one chemical feed distributor may be closely fitted to a distributor width of the one chemical feed distributor.

A twentieth aspect of the present disclosure may include any one of the seventeenth through nineteenth aspects, wherein a difference between a cutout width of the cutout at which the lateral guide is rigidly coupled to the one chemical feed distributor and a distributor width of the one chemical feed distributor may be less than or equal to 0.25 inches.

A twenty-first aspect of the present disclosure may include any one of the seventeenth through twentieth aspects, wherein for each of the cutouts not rigidly coupled to the one of the chemical feed distributors, a surface of the cutout distal from the cutout fixed to the chemical feed distributor may be closely fitted to a surface of the chemical feed distributor partially disposed therein and surface proximate to the cutout fixed to the chemical feed distributor may be spaced apart from the surface of the chemical feed distributor by at least ⅜ inches (0.95 cm) when the gas distribution system is at ambient temperature.

A twenty-second aspect of the present disclosure may include any one of the seventeenth through twenty-first aspects, wherein that at least one lateral guide may be positioned between the intermediate beam and the vessel wall.

A twenty-third aspect of the present disclosure may include any one of the seventeenth through twenty-second aspects, wherein the at least one lateral guide may be positioned proximate terminal ends of one or more of the plurality of chemical feed distributors.

A twenty-fourth aspect of the present disclosure may include the twenty-third aspect, wherein each of the plurality of chemical feed distributors that are engaged with the at least one lateral guide may comprise an insulating material disposed within the terminal end of the chemical feed distributor at a position where the chemical feed distributor engages with the lateral guide.

A twenty-fifth aspect of the present disclosure may include any one of the first through twenty-fourth aspects, further comprising at least one end guide, wherein the at least one end guide may be engaged with terminal ends of a subset of the plurality of chemical feed distributors.

A twenty-sixth aspect of the present disclosure may include the twenty-fifth aspect, wherein the at least one end guide may comprise a lateral guide comprising a flat bar having a plurality of cutouts positioned along one side of the flat bar. Each of the at least one lateral guide may be engaged with a subset of the plurality of the chemical feed distributors at the terminal ends of the chemical feed distributors, each of the plurality of cutouts in the at least one lateral guide may receive at least a portion of one of the plurality of chemical feed distributors, and the lateral guide may be rigidly coupled to one of the chemical feed distributors at least partially disposed in one of the plurality of cutouts.

A twenty-seventh aspect of the present disclosure may include the twenty-sixth aspect, wherein each of the plurality of chemical feed distributors that is engaged with the at least one end guide may comprise an insulating material disposed within the terminal end of the chemical feed distributor at a position where the chemical feed distributor engages with the end guide.

A twenty-eighth aspect of the present disclosure may include the twenty-fifth aspect, wherein the terminal end of each of the plurality of chemical feed distributors may comprise a rod projecting laterally outward from the terminal end and the at least one end guide may comprise a flat bar comprising one or more openings. The rod at the terminal end of each of the subset of the plurality of chemical feed distributors may be disposed within one of the openings in the at least one end guide, and the at least one end guide may be coupled to the rods of each of the plurality of chemical feed distributors in the subset so that the at least one end guide may be slidable on each of the rods.

A twenty-ninth aspect of the present disclosure may include any one of the first through twenty-eighth aspects, further comprising a T-distributor coupled to the vessel wall and extending from the vessel wall into an internal volume of the vessel, wherein each of the T-distributors may be disposed in a portion of the vessel blocked by attachment of the at least one intermediate beam to the vessel wall.

A thirtieth aspect of the present disclosure may include any one of the first through twenty-ninth aspects, wherein one or more of the plurality of chemical feed distributors may comprise at least a first section proximate a chemical feed inlet of the chemical feed distributor and a second section proximate a terminal end of the chemical feed distributor, wherein the second section may have a cross-sectional area less than a cross-sectional area of the first section.

A thirty-first aspect of the present disclosure may include any one of the first through thirtieth aspects, wherein one or more of the plurality of chemical feed distributors may comprise one or more reinforcing bars coupled to the conduit along at least a portion of a length of the chemical feed distributor.

A thirty-second aspect of the present disclosure may include any one of the first through thirty-first aspects, wherein the fluidized bed processing system may be a reactor, a catalyst combustor, a catalyst stripper, or a catalyst conditioner, such as a reactor, a catalyst combustor, a catalyst stripper, or a catalyst conditioner for a hydrocarbon dehydrogenation system.

A thirty-third aspect of the present disclosure may include any one of the first through thirty-second aspects, wherein the vessel has an internal diameter of greater than or equal to 15 feet.

A thirty-fourth aspect of the present disclosure may be directed to a fluidized bed processing system that includes a vessel comprising a vessel wall and a plurality of chemical feed distributors coupled to the vessel wall and extending from the vessel wall into an internal volume of the vessel. Each of the chemical feed distributors may comprise a distributor body forming a chemical feed flow path and a plurality of chemical feed outlets distributed along a length of the distributor body. The fluidized bed processing system may include at least one intermediate beam comprising at plurality of slots spaced apart along a beam length, wherein each chemical feed distributor passes through one slot of the at least one intermediate beam. The fluidized bed processing system may further include at least one chair coupled to the vessel wall. The at least one end of the intermediate beam is engaged with the at least one chair, and the at least one chair allows for thermal expansion of the beam.

A thirty-fifth aspect of the present disclosure may include the thirty-fourth aspects, wherein the at least one intermediate beam provides vertical support for each of the plurality of chemical feed distributors.

A thirty-sixth aspect of the present disclosure may include either one of the thirty-fourth or thirty-fifth aspects, wherein the chair may include at least a base and two sidewalls extending in a vertical direction from the base and at least a portion of the end of the intermediate beam may be received in a cradle defined by the base and two sidewalls of the chair.

A thirty-seventh aspect of the present disclosure may include the thirty-sixth aspect, wherein the base may include one or a plurality of mounting slots that may allow the end of the at least one intermediate beam slide relative to the base to allow for thermal expansion of the intermediate beam.

A thirty-eighth aspect of the present disclosure may include any one of the thirty-sixth through thirty-seventh aspects, wherein the chairs further comprise one or more openings in the base that allow catalyst particles and fluids to pass through the base.

A thirty-ninth aspect of the present disclosure may include any one of the thirty-sixth through thirty-eighth aspects, wherein the base, the two sidewalls, or both comprise one or more cutouts at an edge welded to the vessel wall or to a mounting plate coupled to the vessel wall, wherein the cutouts may reduce the amount of heat transferred from the chairs and the at least one intermediate beam to the vessel wall.

Finally, it will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A fluidized bed processing system, the fluidized bed processing system comprising:
a vessel comprising a vessel wall;
a plurality of chemical feed distributors coupled to the vessel wall and extending from the vessel wall into an internal volume of the vessel, each of the chemical feed distributors comprising a distributor body forming a chemical feed flow path and a plurality of chemical feed outlets distributed along a length of the distributor body; and
at least one intermediate beam comprising at plurality of slots spaced apart along a beam length, wherein:
the at least one intermediate beam is coupled to the vessel wall at both ends;
each of the plurality of chemical feed distributors passes through one slot of the at least one intermediate beam; and
the at least one intermediate beam provides vertical support for each of the plurality of chemical feed distributors.

2. The fluidized bed processing system of claim 1, wherein a clearance between each of the plurality of chemical feed distributors and one or both side surfaces of the slot of the at least one intermediate beam is sufficient to allow for thermal expansion of the at least one intermediate beam without influencing the lateral position of any of the plurality of chemical feed distributors.

3. The fluidized bed processing system of claim 1, wherein a difference between a greatest horizontal dimension of the chemical feed distributor and a slot width of the slot is greater than or equal to 0.125 inches.

4. The fluidized bed processing system of claim 1, wherein at least one end of the at least one intermediate beam is slidable laterally relative to the vessel wall.

5. The fluidized bed processing system of claim 1, wherein both ends of the at least one intermediate beam are slidably coupled to the vessel wall and slot widths of the plurality of slots in the at least one intermediate beam increase from a horizontal center of the at least one intermediate beam laterally outward towards each end of the at least one intermediate beam.

6. The fluidized bed processing system of claim 1, comprising:
a first plurality of chemical feed distributors and at least one first intermediate beam; and
a second plurality of chemical feed distributors and at least one second intermediate beam, wherein:
the first plurality of chemical feed distributors are coupled to a first side of the vessel wall and extend through the slots in the at least one first intermediate beam; and
the second plurality of chemical feed distributors are coupled to a second side of the vessel wall opposite the first side and the second plurality of chemical feed distributors extend through the slots in the at least one second intermediate beam.

7. The fluidized bed processing system of claim 1, further comprising at least one lateral guide comprising a flat bar having a plurality of cutouts positioned along one side of the flat bar, wherein:
each of the at least one lateral guide is engaged with a subset of the plurality of the chemical feed distributors;
each of the plurality of cutouts in the at least one lateral guide receives at least a portion of one of the plurality of chemical feed distributors;
the lateral guide is rigidly coupled to one of the chemical feed distributors at least partially disposed in one of the plurality of cutouts; and
contact between the lateral guide and the portion of the chemical feed distributors received in the cutouts restricts lateral movement of the chemical feed distributors.

8. The fluidized bed processing system of claim 7, wherein a difference between a cutout width of the cutout at which the lateral guide is rigidly coupled to the one chemical feed distributor and a distributor width of the one chemical feed distributor is less than or equal to 0.25 inches.

9. The fluidized bed processing system of claim 7, wherein for each cutout not rigidly coupled to the one of the chemical feed distributors, a surface of the cutout distal from the cutout fixed to the chemical feed distributor is closely fitted to a surface of the chemical feed distributor partially disposed therein and surface proximate to the cutout fixed to the chemical feed distributor is spaced apart from the surface of the chemical feed distributor by at least ⅜ inches when the gas distribution system is at ambient temperature.

10. The fluidized bed processing system of claim 7, wherein the at least one lateral guide is positioned proximate terminal ends of one or more of the plurality of chemical feed distributors.

11. The fluidized bed processing system of claim 10, wherein each of the plurality of chemical feed distributors engaged with the at least one lateral guide comprises an insulating material disposed within the terminal end of the chemical feed distributor at a position where the chemical feed distributor engages with the lateral guide.

12. The fluidized bed processing system of claim 1, further comprising a T-distributor coupled to the vessel wall and extending from the vessel wall into an internal volume of the vessel, wherein the T-distributor is disposed in a portion of the vessel blocked by attachment of the at least one intermediate beam to the vessel wall.

13. The fluidized bed processing system of claim 1, wherein one or more of the plurality of chemical feed distributors comprises at least a first section proximate a chemical feed inlet of the chemical feed distributor and a second section proximate a terminal end of the chemical feed distributor, wherein the second section has a cross-sectional area less than a cross-sectional area of the first section.

14. The fluidized bed processing system of claim 1, wherein one or more of the plurality of chemical feed distributors comprises one or more reinforcing bars coupled to the conduit along at least a portion of a length of the chemical feed distributor.

15. The fluidized bed processing system of claim 1, wherein the fluidized bed processing system is a reactor, a catalyst combustor, a catalyst stripper, or a catalyst conditioner.
